(19) United States
(12) Patent Application Publication
(10) Pub. No.: US 2023/0145125 A1
(43) Pub. Date: May 11, 2023

(54) COMPUTER-READABLE RECORDING MEDIUM STORING INFORMATION PROCESSING PROGRAM, INFORMATION PROCESSING APPARATUS, AND INFORMATION PROCESSING METHOD

(71) Applicant: FUJITSU LIMITED, Kawasaki-shi (JP)

(72) Inventor: Yosuke OYAMA, Kawasaki (JP)

(73) Assignee: FUJITSU LIMITED, Kawasaki-shi (JP)

(21) Appl. No.: 17/862,435

(22) Filed: Jul. 12, 2022

(30) Foreign Application Priority Data
Nov. 10, 2021 (JP) 2021-183015

(51) Int. Cl. G06F 17/16; G06F 9/52; G06F 9/38

(52) U.S. Cl. CPC G06F 17/16; G06F 9/52; G06F 9/3893

(57) ABSTRACT

A recording medium stores a program for causing a computer to execute a process including: determining, by using each of processes included in a matrix process as a first process and using a process next to the first process as a second process, a synchronization method for processing units that process elements of a first portion of a matrix, based on the number of the processing units that process the elements of the first portion in the first process and the number of processing units that process elements of a second portion of the matrix in the second process; executing the first process by using the processing units that process the elements of the first portion; executing a synchronization process on the processing units that process the elements of the first portion; and executing the second process by using the processing units that process the elements of the second portion.

### CROSS-REFERENCE TO RELATED APPLICATION

This application is based upon and claims the benefit of priority of the prior Japanese Patent Application No. 2021-183015, filed on Nov. 10, 2021, the entire contents of which are incorporated herein by reference.

### FIELD

The embodiments discussed herein are related to an information processing technology.

### BACKGROUND

A huge sparse matrix may be used in scientific calculations. Since memory consumption is increased when a sparse matrix is stored in a memory by using a dense matrix format, a sparse matrix format in which only non-zero elements of a sparse matrix are stored in a memory is used. As the sparse matrix format, for example, a coordinate (COO) format and a compressed sparse row (CSR) format are known. By using the sparse matrix format, it is possible to reduce memory consumption and a size of data to be read.

Japanese Laid-open Patent Publication No. 2016-119084 and U.S. Pat. No. 2015/0042672 are disclosed as related art.

“cuSPARSE Library”, NVIDIA, September 2021, [online], [searched on Sep. 10, 2021], Internet <URL:https://docs.nvidia.com/cuda/pdf/CUSPARSE_Library.pdf>, E. F. Kaasschieter, “Preconditioned conjugate gradients for solving singular systems”, Journal of Computational and Applied mathematics 24, 1988, pages 265-275, “Biconjugate Gradient Method”, Wolfram MathWorld, Sep. 19, 2021, [online], [searched on Oct. 1, 2021], Internet <URL:https://mathworld.wolfram.com/BiconjugateGradientMethod.html>, C. Pommerell, “Solution of large unsymmetric systems of linear equations”, 1992, pages 1-207, “OpenFOAM-dev/src/OpenFOAM/matrices/IduMatrix/preconditioners/DILUPreconditioner/DILU Preconditioner.C”, GitHub, [online], [searched on Oct. 1, 2021], Internet <URL:https://github.com/OpenFOAM/OpenFOAM-dev/blob/master/src/OpenFOAM/matrices/lduMatrix/preconditioners/DILUPrecon ditioner/DILUPreconditioner.C>, E. Cuthill and J. McKee, “REDUCING THE BANDWIDTH OF SPARSE SYMMETRIC MATRICES”, In Proceedings of the 1969 24th national conference, Association for Computing Machinery, August 1969, pages 157-172, “CHALLENGE for OpenFOAM THREAD PARALLELIZATION”, November 5, Naoki Yoshifuji, 2019, [online], [Searched on Sep. 10, 2021], Internet <URL:https://proc-cpuinfo.fixstars.com/2019/11/openfoam-dic-pcg/>, “AMGX REFERENCE MANUAL”, NVIDIA, October 2017, [online], [searched on Sep. 10, 2021], Internet <URL:https://github.com/NVIDIA/AMGX/blob/main/doc/AMGX_Reference.pdf>, “CUDA 9 AND MORE”, Akira Naruse, Dec. 12, 2017, [online], [searched on Sep. 10, 2021], Internet <URL:https://www.nvidia.com/content/apac/gtc/ja/pdf/2017/1041.pdf>, and “AMGX/core/src/solvers/multicolor_dilu_solver.cu”, GitHub, [online], [searched on Sep. 10, 2021], Internet <URL:https://github.com/NVIDIA/AMGX/blob/main/core/src/solvers/multicolor_di lu_solver.cu> are also disclosed as related art.

### SUMMARY

According to an aspect of the embodiments, a non-transitory computer-readable recording medium stores an information processing program for causing a computer to execute a process including: determining, by using each of a plurality of processes included in a matrix process as a first process and using a process next to the first process as a second process, a synchronization method for one or a plurality of processing units that process elements of a first portion of a matrix in parallel, based on the number of the one or the plurality of processing units that process the elements of the first portion of the matrix in parallel in the first process and the number of one or a plurality of processing units that process elements of a second portion of the matrix in parallel in the second process; executing the first process by using the one or the plurality of processing units that process the elements of the first portion of the matrix in parallel; executing a synchronization process on the one or the plurality of processing units that process the elements of the first portion of the matrix in parallel by using the synchronization method; and executing the second process by using the one or the plurality of processing units that process the elements of the second portion of the matrix in parallel.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating memory access to matrix data;

FIG. 2 is a diagram illustrating an algorithm of a PCG method;

FIG. 3 is a diagram illustrating a coefficient matrix;

FIG. 4 is a diagram illustrating an algorithm of a PBiCG method;

FIG. 5A is a diagram illustrating an object initialization process of a program for a DILU precondition;

FIG. 5B is a diagram illustrating a precondition of the program for the DILU precondition;

FIG. 6 is a diagram illustrating a lower triangular matrix;

FIG. 7 is a diagram illustrating an iteration direction of face;

FIG. 8 is a diagram illustrating 4 substitution processes included in the DILU precondition;

FIG. 9 is a diagram illustrating an iteration direction in 4 substitution processes;

FIG. 10 is a diagram illustrating a substitution process included in the DILU precondition and a DIC precondition;

FIG. 11 is a diagram illustrating an upper triangular matrix;

FIG. 12 is a diagram illustrating column coloring in the upper triangular matrix;

FIG. 13 is a diagram illustrating parallelization of forward substitution in the DIC precondition;

FIG. 14 is a diagram illustrating parallelization based on column coloring;

FIG. 15 is a diagram illustrating row coloring in the upper triangular matrix;

FIG. 16 is a diagram illustrating parallelization of backward substitution in the DIC precondition;

FIG. 17 is a diagram illustrating parallelization based on row coloring;

FIG. 18 is a diagram illustrating a loop process of the DIC precondition and the DILU precondition;

FIG. 19 is a diagram illustrating parallelization of forward substitution in the DILU precondition;

FIG. 20 is a diagram illustrating a calculation process based on graph coloring;

FIGS. 21A and 21B are diagrams illustrating the number of rows for each color in a fluid analysis simulation;

FIGS. 22A to 22C are diagrams illustrating a synchronization method between threads;

FIGS. 23A to 23C are diagrams illustrating a calculation process to which the synchronization method is applied;

FIG. 24 is a functional configuration diagram of an information processing apparatus;

FIG. 25 is a flowchart of an arithmetic process;

FIG. 26 is a functional configuration diagram illustrating a specific example of the information processing apparatus;

FIG. 27 is a diagram illustrating an example of information stored in a storage unit;

FIG. 28 is a diagram illustrating information stored in a storage unit in a GPU;

FIG. 29 is a diagram illustrating a synchronization process in a calculation process using threads;

FIG. 30 is a diagram illustrating the upper triangular matrix;

FIG. 31 is a diagram illustrating a calculation process using the upper triangular matrix;

FIG. 32 is a diagram illustrating a synchronization method in the fluid analysis simulation;

FIG. 33 is a diagram illustrating a comparison result of parallelization methods;

FIG. 34 is a flowchart of an analysis process;

FIG. 35 is a flowchart of a column coloring information generation process;

FIG. 36 is a diagram illustrating a first color ID update process;

FIG. 37 is a diagram illustrating a second color ID update process;

FIG. 38 is a flowchart of a process of calculating a precondition residual of the DIC precondition;

FIG. 39 is a flowchart of a process of calculating a precondition residual of the DILU precondition;

FIG. 40 is a flowchart of an enqueue process;

FIGS. 41A and 41B are a flowchart of a thread process;

FIG. 42 is a flowchart of a DIC forward substitution thread process;

FIG. 43 is a diagram illustrating sf for the upper triangular matrix;

FIG. 44 is a flowchart of a DILU forward substitution thread process;

FIG. 45 is a flowchart of a DILU backward substitution thread process;

FIG. 46 is a diagram illustrating a timeline of a first DIC forward substitution thread process;

FIG. 47 is a diagram illustrating a timeline of a second DIC forward substitution thread process;

FIG. 48 is a hardware configuration diagram of an information processing apparatus including a plurality of nodes;

FIG. 49 is a diagram illustrating performance in the fluid analysis simulation;

FIGS. 50A and 50B are diagrams illustrating the number of preconditions and the number of smoothers; and

FIG. 51 is a hardware configuration diagram of the information processing apparatus.

### DESCRIPTION OF EMBODIMENTS

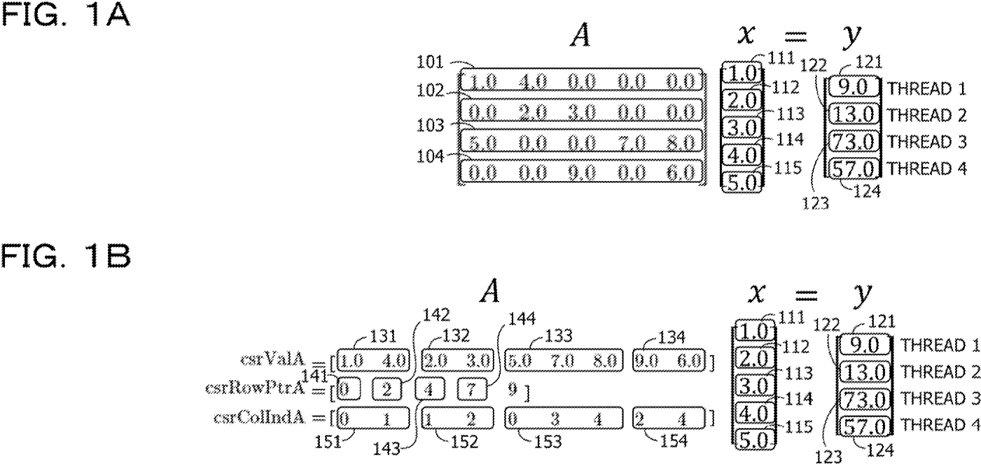

FIGS. 1A and 1B illustrate an example of memory access to matrix data stored in a memory. FIG. 1A illustrates an example of memory access in general matrix-vector multiplication (GEMV) in a case where a coefficient matrix A is stored in a memory by using a dense matrix format.

In this example, a matrix vector product is calculated as in the following equation.

$$\text{Ax} = \text{y}$$

x represents a vector, and y represents a vector that is a multiplication result of a matrix A and the vector x. The matrix A is a sparse matrix. A thread 1 calculates an element 121 of the vector y, a thread 2 calculates an element 122 of the vector y, a thread 3 calculates an element 123 of the vector y, and a thread 4 calculates an element 124 of the vector y.

In this case, the thread 1 accesses an element 101 of the matrix A and element 111 to element 115 of the vector x, and the thread 2 accesses an element 102 of the matrix A and the element 111 to the element 115 of the vector x. The thread 3 accesses an element 103 of the matrix A and the element 111 to the element 115 of the vector x, and the thread 4 accesses an element 104 of the matrix A and the element 111 to the element 115 of the vector x.

The memory access from each thread to the matrix A and the vector x in FIG. 1A is continuous access.

FIG. 1B illustrates an example of memory access in a sparse matrix-vector multiplication (SpMV) in a case where the matrix A is stored in a memory by using a CSR format. In this case, matrix data of the matrix A is stored in the memory by using an array csrValA, an array csrRowPtrA, and an array csrColIndA.

The thread 1 accesses an element 131 of the array csrValA, an element 141 of the array csrRowPtrA, an element 151 of the array csrColIndA, and the element 111 and the element 112 of the vector x. The thread 2 accesses an element 132 of the array csrValA, an element 142 of the array csrRowPtrA, an element 152 of the array csrColIndA, and the element 112 and the element 113 of the vector x.

The thread 3 accesses an element 133 of the array csrValA, an element 143 of the array csrRowPtrA, an element 153 of the array csrColIndA, and the element 111, the element 114, and the element 115 of the vector x. The thread 4 accesses an element 134 of the array csrValA, an element 144 of the array csrRowPtrA, an element 154 of the array csrColIndA, and the element 113 and the element 115 of the vector x.

The access from the thread 1, the thread 2, the thread 3, and the thread 4 to the matrix A in FIG. 1B causes load imbalance, and the access from each thread to the vector x is random access. In this manner, since memory access to matrix data in the sparse matrix format is irregular access, it is desirable to devise a formatting algorithm.

A preconditioned conjugate gradient method (PCG method) and a biconjugate gradient method are known, in association with matrix calculation using a sparse matrix. A solution of a large-scale asymmetric simultaneous linear equation is also known.

A program for a diagonal-based incomplete LU (DILU) precondition is also known. A method for reducing a bandwidth of a symmetric sparse matrix is also known. A parallelization method of a diagonal-based incomplete Cholesky (DIC) precondition and a DILU precondition by coloring is also known.

A thread synchronization method in a graphics processing unit (GPU) environment is also known.

A computer-implemented system for efficient sparse matrix representation and a process is also known. A parallel multicolor incomplete LU decomposition preconditioning processor is also known.

In a case where a DIC precondition or a DILU precondition is parallelized by coloring, a synchronization process occurs between a plurality of threads. Depending on a synchronization method applied to the synchronization process, a cost of the synchronization process may be increased and processing efficiency may be decreased.

Such a problem occurs not only in the DIC precondition and the DILU precondition using threads but also in various matrix calculations using various processing units.

In one aspect, an object of the present disclosure is to improve processing efficiency of a parallel process using a matrix.

Hereinafter, embodiments are described in detail with reference to the drawings.

First, as an example of matrix calculation using a sparse matrix, a solution of a simultaneous linear equation as in the following equation will be described.

$$\text{Ax} = \text{b}$$

A represents a coefficient matrix, b represents a constant vector, and x represents an unknown vector. A sparse matrix is used as the matrix A.

In a case where the matrix A is a symmetric matrix, Equation (2) is a symmetric simultaneous linear equation, and in a case where the matrix A is an asymmetric matrix, Equation (2) is an asymmetric simultaneous linear equation. As an iteration method of the symmetric simultaneous linear equation, for example, a PCG method is used. As an iteration method of the asymmetric simultaneous linear equation, for example, a preconditioned biconjugate gradient method (PBiCG method) is used.

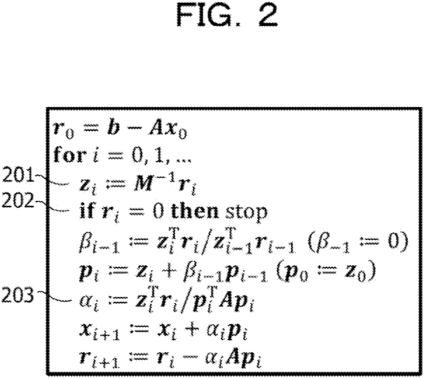

FIG. 2 illustrates an example of an algorithm of a PCG method described in E. F. Kaasschieter, “Preconditioned conjugate gradients for solving singular systems”, Journal of Computational and Applied mathematics 24, 1988, pages 265-275. In an equation 201, M represents a preconditioning matrix, and M⁻¹ represents an inverse matrix of M. A vector rᵢ represents a residual. The equation 201 represents a precondition for calculating a sparse matrix-vector multiplication of M⁻¹ and rᵢ in the PCG method. The precondition of calculating the sparse matrix-vector multiplication of M⁻¹ and rᵢ is an example of a matrix process.

An if statement 202 represents a stop condition of a for loop in the PCG method. Practically, in a case where a size of the rᵢ becomes smaller than an appropriate threshold value ε, the calculation is terminated. An equation 203 represents a sparse matrix-vector multiplication using the matrix A. With the algorithm in FIG. 2, convergence of the solution is improved by the precondition.

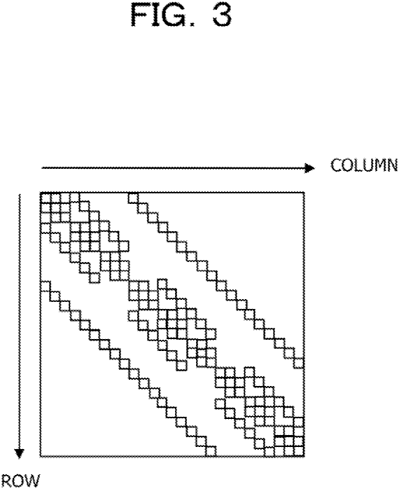

FIG. 3 illustrates an example of a coefficient matrix. The coefficient matrix in FIG. 3 is a coefficient matrix of a PCG solver that calculates a pressure of 3×3×3 cubic lattice in a fluid analysis application, and is a square matrix having 27 rows and 27 columns. In this cubic lattice, each lattice point is adjacent to a maximum of six lattice points existing in up-down, left-right, front-rear directions. A small square of the coefficient matrix represents a non-zero element.

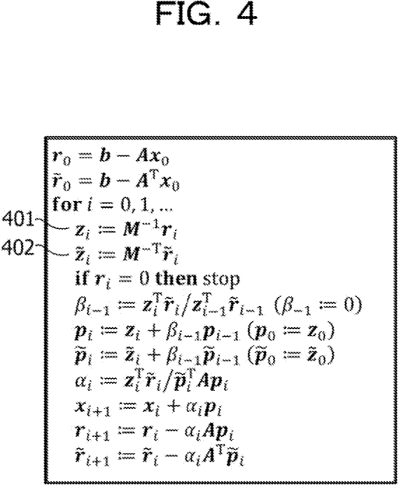

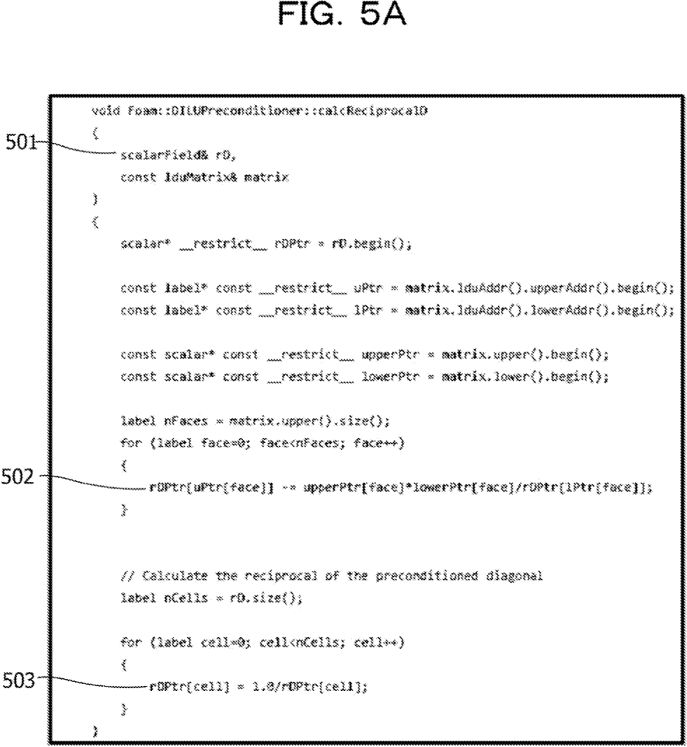

FIG. 4 illustrates an example of an algorithm of a PBiCG method. An equation 401 corresponds to the equation 201 in FIG. 2. In the equation 402, M^{-T} represents a transposed matrix of M⁻¹. M^{-T} corresponds to an inverse matrix of a transposed matrix M^{T} of M. The equation 401 and equation 402 represent a precondition in the PBiCG method. The precondition in the PBiCG method is an example of a matrix process. In a case where the matrix A is a symmetric matrix, the algorithm of the PBiCG method matches the algorithm of the PCG method.

An incomplete decomposition precondition is a method for reducing the amount of calculation of the precondition by simplifying LDU decomposition of the matrix M. The LDU decomposition of the matrix M is described by the following equation.

$$\text{M} = \text{LDU}$$

L represents a lower triangular matrix, D represents a diagonal matrix, and U represents an upper triangular matrix. In C. Pommerell, “Solution of large unsymmetric systems of linear equations”, 1992, pages 1-207, a Jacobi precondition, a symmetric successive over-relaxation (SSOR) precondition, a DILU precondition, and the like are described as the incomplete decomposition precondition. Depending on a type of the incomplete decomposition precondition, calculation accuracy and the calculation amount of the incomplete decomposition precondition are in a trade-off relationship.

The matrix A may be described by the following equation.

$$\text{A} = {\text{L}}_{\text{A}} + {\text{D}}_{\text{A}} + {\text{U}}_{\text{A}}$$

L_{A} is a lower triangular matrix representing a lower triangular element of the matrix A, D_{A} is a diagonal matrix representing a diagonal element of the matrix A, and U_{A} is an upper triangular matrix representing an upper triangular element of the matrix A. Meanwhile, the lower triangular matrix L_{A} and the upper triangular matrix U_{A} do not include the diagonal element of the matrix A. Hereinafter, this decomposition method is referred to as an LDU format.

LDU decomposition of the matrix M in a DILU precondition is described by the following equation by using a matrix D in Equation (3).

$$\text{M} = \left({\text{L}}_{\text{A}} + \text{D}\right) {\text{D}}^{- 1} \left(\text{D} + {\text{U}}_{\text{A}}\right)$$

In this case, the matrix M⁻¹ in FIG. 4 is described by the following equation.

$${\text{M}}^{- 1} = {\left(\left({\text{L}}_{\text{A}} + \text{D}\right) {\text{D}}^{- 1} \left(\text{D} + {\text{U}}_{\text{A}}\right)\right)}^{- 1}$$

$$\text{=} {\left(\text{D} + {\text{U}}_{\text{A}}\right)}^{- 1} \text{D} {\left({\text{L}}_{\text{A}} + \text{D}\right)}^{- 1}$$

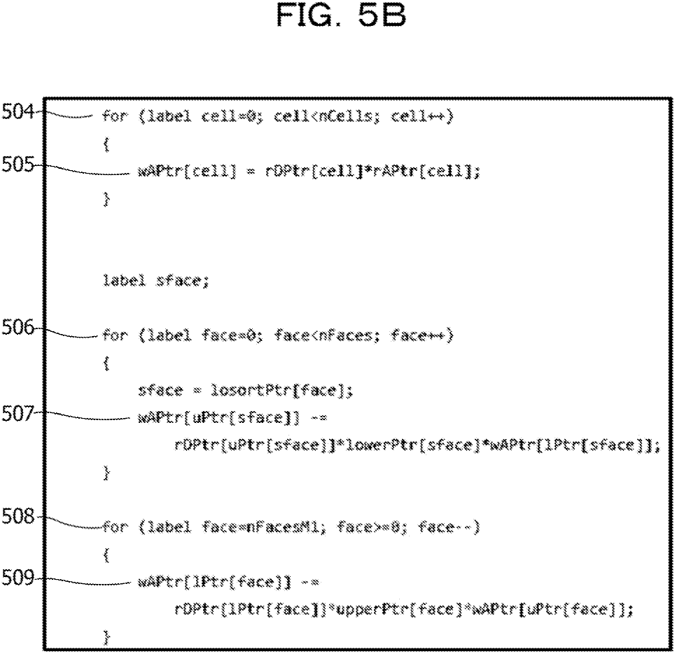

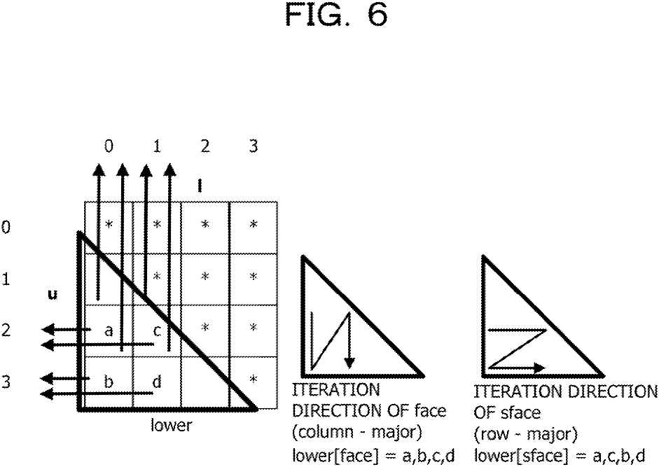

FIG. 5A illustrates an object initialization process included in a program for the DILU precondition described in “OpenFOAM-dev/src/OpenFOAM/matrices/lduMatrix/preconditioners/DILUPreconditioner/DILU Preconditioner.C”, GitHub, [online], [searched on Oct. 1, 2021], Internet <URL:https://github.com/OpenFOAM/OpenFOAM-dev/blob/master/src/OpenFOAM/matrices/lduMatrix/preconditioners/DILUPrecon ditioner/DILUPreconditioner.C>. An argument rD of a sentence 501 represents a copy of a matrix D_{A}, and sentences 502 and 503 represent a process of calculating and holding an inverse matrix D⁻¹ of the matrix D (D⁻¹ calculation). A reciprocal ⅟dᵢᵢ of an element dᵢᵢ of an i-th row and an i-th column of the matrix D is stored in rDPtr[i] (i = cell) of the sentence 503.

By calculating rDu = aᵢⱼ/ⱼⱼ and rDI = aᵢⱼ/dᵢᵢ in advance, the precondition is speeded up in faster version of DIC (FDIC). aᵢⱼ represents an element of an i-th row and a j-th column of the matrix A.

FIG. 5B illustrates a precondition included in a program for a DILU precondition described in “OpenFOAM-dev/src/OpenFOAM/matrices/IduMatrix/preconditioners/DILUPreconditioner/DILU Preconditioner.C”, GitHub, [online], [searched on Oct. 1, 2021], Internet <URL:https://github.com/OpenFOAM/OpenFOAM-dev/blob/master/src/OpenFOAM/matrices/lduMatrix/preconditioners/DILUPrecon ditioner/DILUPreconditioner.C>. Hereinafter, for the sake of simplicity, an array name included in a program may be referred to by omitting Ptr. For example, rAPtr is referred to as rA, and wAPtr is referred to as wA.

The argument rA in an equation 505 of a for loop 504 represents a residual b - Axᵢ in FIG. 4, and a return value wA in an equation 509 of a for loop 508 represents the precondition residual M⁻¹(b - Axᵢ). The precondition residual M⁻¹(b - Axᵢ) is calculated by the for loop 504, a for loop 506, and the for loop 508.

The equation 505 of the for loop 504 represents a process of calculating D⁻¹rA and storing D⁻¹rA in wA. An equation 507 of the for loop 506 and the equation 509 of the for loop 508 represent subtraction and substitution for wA. The equation 507 represents a forward substitution process in which (L_{A} + D)⁻¹rA is calculated and stored in wA, and The equation 509 represents a backward substitution process in which (D + U_{A})⁻¹DwA is calculated and stored in wA.

With the for loop 506 and the for loop 508, the iterative inverse matrix calculation and the matrix vector product calculation of the lower triangular matrix and the upper triangular matrix are simultaneously performed. At a time point when the process of the for loop 508 is completed, the precondition residual M⁻¹(b - Axᵢ) is stored in wA.

A transposed version of the precondition in FIG. 5B is also included in the program for the DILU precondition in “OpenFOAM-dev/src/OpenFOAM/matrices/lduMatrix/preconditioners/DILUPreconditioner/DILU Preconditioner.C”, GitHub, [online], [searched on Oct. 1, 2021], Internet <URL:https://github.com/OpenFOAM/OpenFOAM-dev/blob/master/src/OpenFOAM/matrices/lduMatrix/preconditioners/DILUPrecon ditioner/DILUPreconditioner.C>. The precondition in FIG. 5B and the precondition of the transposed version is called once for each, for each step of the PBiCG method. The precondition of the transposed version is not included in a program for a DIC precondition.

Next, an example in which the process of the for loop 504 and the for loop 506 illustrated in FIG. 5B is equivalent to the process of wA ← (L_{A} + D)⁻ ¹rA will be described. For the sake of simplicity, wA = w, and rA = r are used. In a case where the matrix L_{A} and the matrix D are square matrices of n rows and n columns, and w and r are n-dimensional vectors, elements of the matrix D, the matrix L_{A}, the vector w, and the vector r may be described as the following equations.

$$D = \left(\begin{matrix}{d}_{1 , 1} & & \\ & ⋱ & \\ & & {d}_{n , n}\end{matrix}\right)$$

$${L}_{A} = \left(\begin{matrix}0 & & & \\ {a}_{2 , 1} & 0 & & \\ ⋮ & ⋱ & ⋱ & \\ {a}_{n , 1} & ⋯ & {a}_{n , n - 1} & 0\end{matrix}\right)$$

$$w = {\left\{{w}_{i}\right\}}_{i = 1}^{n} = \left(\begin{matrix}{w}_{1} \\ {w}_{2} \\ ⋮ \\ {w}_{n}\end{matrix}\right)$$

$$r = {\left\{{r}_{i}\right\}}_{i = 1}^{n} = \left(\begin{matrix}{r}_{1} \\ {r}_{2} \\ ⋮ \\ {r}_{n}\end{matrix}\right)$$

From w = (L_{A} + D)⁻¹r, the following equation is obtained.

$$\left(\begin{matrix}{d}_{1 , 1} & & & \\ {a}_{2 , 1} & {d}_{2 , 2} & & \\ ⋮ & & ⋱ & \\ {a}_{n , 1} & {a}_{n , 2} & ⋯ & {d}_{n , n}\end{matrix}\right) w = \left(\begin{matrix}{r}_{1} \\ {r}_{2} \\ ⋮ \\ {r}_{n}\end{matrix}\right)$$

By multiplying first rows of both sides of Equation (15) by ⅟d_{1,1}, the following equation is obtained.

$$\left(\begin{matrix}1 & & & \\ {a}_{2 , 1} & {d}_{2 , 2} & & \\ ⋮ & & ⋱ & \\ {a}_{n , 1} & {a}_{n , 2} & ⋯ & {d}_{n , n}\end{matrix}\right) w = \left(\begin{matrix}{d}_{1 , 1} {}^{- 1} {r}_{1} \\ {r}_{2} \\ ⋮ \\ {r}_{n}\end{matrix}\right)$$

By subtracting a result obtained by multiplying first rows of both sides of Equation (16) by a_{2,1} from a second row and then multiplying the second row by ⅟d_{2,2}, the following equation is obtained.

$$\left(\begin{matrix}1 & & & & \\ & 1 & & & \\ {a}_{3 , 1} & {a}_{3 , 2} & {d}_{3 , 3} & & \\ ⋮ & & ⋱ & ⋱ & \\ {a}_{n , 1} & {a}_{n , 2} & ⋯ & {a}_{n , n - 1} & {d}_{n , n}\end{matrix}\right) w = \left(\begin{matrix}{d}_{1 , 1} {}^{- 1} {r}_{1} \\ {d}_{2 , 2} {}^{- 1} {r}_{2} - {d}_{2 , 2} {}^{- 1} {a}_{2 , 1} {d}_{1 , 1} {}^{- 1} {r}_{1} \\ {r}_{3} \\ ⋮ \\ {r}_{n}\end{matrix}\right)$$

Considering recursively from both sides of Equation (17), the following equation is established.

$$w = {\left\{{d}_{i , i} {}^{- 1} {r}_{i} - {\sum }_{j = 1}^{i - 1} {d}_{i , i} {}^{- 1} {a}_{i , j} {v}_{j}\right\}}_{i = 1}^{n}$$

vⱼ represents a j-th element of a vector of a right side of Equation (18). A first term of the right side of Equation (18) corresponds to the equation 505 of the for loop 504, and a second term corresponds to the equation 507 of the for loop 506.

FIG. 6 illustrates an example of the lower triangular matrix L_{A} in a sparse matrix in an LDU format. In this example, the matrix L_{A} is a matrix having 4 rows and 4 columns, and row positions and column positions are represented by 0 to 3. Non-zero elements of the matrix L_{A} are a, b, c, and d.

In lower of the equation 507, only the non-zero elements of the matrix L_{A} are stored in an order of column-major in which elements are consecutive in a column direction. The column position corresponding to each element of lower is stored in I, and a row position is stored in u. An index of lower corresponding to each non-zero element in a case where the non-zero elements of the lower triangular matrix L_{A} are arranged in an order of row-major in which elements are continuous in a row direction is stored in losort. Therefore, lower, l, u, and losort are as follows.

lower = [a, b, c, d], l = [0, 0, 1, 1], u = [2, 3, 2, 3], losort = [0, 2, 1, 3]

In this case, indices of each array are 4 of 0 to 3. a, b, c, and d are obtained when the non-zero elements are sorted based on column-major, and a, c, b, and d are obtained when the non-zero elements are sorted based on row-major. Since the indices of lower corresponding to a, b, c, and d are respectively 0, 1, 2, and 3, these indices are stored in the losort in an order of 0, 2, 1, and 3.

An index face of the for loop 506 represents an index of lower, and changes from 0 to nFaces - 1 in ascending order. nFaces represents the number of non-zero elements of the matrix L_{A}. In a case where face is changed from 0 to nFaces - 1, sface = losort[face] represents an index for accessing the non-zero element of the matrix L_{A} by row-major.

Assuming that i = u[sface] and j = l[sface], wA[u[sface]] of the left side of the equation 507 corresponds to the wᵢ of the left side of Equation (18). rD[u[sface]] of the right side of the equation 507 corresponds to d_{i,j}⁻¹ of the second term of the right side of Equation (18), lower[sface] corresponds to a_{i,j}, and wA[l[sface]]corresponds to vⱼ. Therefore, it may be seen that the equation 507 represents the subtraction of the second term of the right side of Equation (18).

Next, an equivalence between the process of the for loop 508 in FIG. 5B and the process of wA ← (D + U_{A})⁻¹DwA will be described. For the sake of simplicity, wA of a storage destination = z and wA of a reading source = w are used. Elements of the matrix U_{A} and the vector z may be described by the following equations.

$${U}_{A} = \left(\begin{matrix}0 & {a}_{1 , 2} & ⋯ & {a}_{1 , n} \\ & 0 & ⋱ & ⋮ \\ & & ⋱ & {a}_{n - 1 , n} \\ & & & 0\end{matrix}\right)$$

$$z = {\left\{{z}_{i}\right\}}_{i = 1}^{n} = \left(\begin{matrix}{z}_{1} \\ {z}_{2} \\ ⋮ \\ {z}_{n}\end{matrix}\right)$$

From z = (D + U_{A})⁻¹Dw, the following equation is obtained.

$$\left(\begin{matrix}{d}_{1 , 1} & {a}_{1 , 2} & ⋯ & {a}_{1 , n} \\ & {d}_{2 , 2} & ⋱ & ⋮ \\ & & ⋱ & {a}_{n - 1 , n} \\ & & & {d}_{n , n}\end{matrix}\right) z = \left(\begin{matrix}{d}_{1 , 1} & & \\ & ⋱ & \\ & & {d}_{n , n}\end{matrix}\right) \left(\begin{matrix}{w}_{1} \\ ⋮ \\ {w}_{n}\end{matrix}\right)$$

By multiplying n-th rows of both sides of Equation (21) by ⅟d_{n,n}, the following equation is obtained.

$$\begin{matrix}\left(\begin{matrix}{d}_{1 , 1} & {a}_{1 , 2} & ⋯ & ⋯ & {a}_{1 , n} \\ & {d}_{2 , 2} & ⋱ & & ⋮ \\ & & ⋱ & ⋱ & ⋮ \\ & & & {d}_{n - 1 , n - 1} & {a}_{n - 1 , n} \\ & & & & 1\end{matrix}\right) z = \\ \left(\begin{matrix}{d}_{1 , 1} & & & \\ & ⋱ & & \\ & & {d}_{n - 1 , n - 1} & \\ & & & 1\end{matrix}\right) \left(\begin{matrix}{w}_{1} \\ ⋮ \\ {w}_{n - 1} \\ {w}_{n}\end{matrix}\right)\end{matrix}$$

After subtracting a result obtained by multiplying n-th rows of both sides of Equation (22) by a_{n-1,n} from an (n-1)-th row and then multiplying the (n - 1)-th row by ⅟d_{n-1,n-1}, the following equation is obtained.

$$\begin{matrix}\left(\begin{matrix}{d}_{1 , 1} & {a}_{1 , 2} & ⋯ & ⋯ & {a}_{1 , n} \\ & ⋱ & ⋱ & & ⋮ \\ & & {d}_{n - 2 , n - 2} & {a}_{n - 2 , n - 1} & {a}_{n - 2 , n} \\ & & & 1 & \\ & & & & 1\end{matrix}\right) z = \\ \left(\begin{matrix}{d}_{1 , 1} & & & \\ & ⋱ & & \\ & & 1 & \\ & & & 1\end{matrix}\right) \left(\begin{matrix}{w}_{1} \\ ⋮ \\ {w}_{n - 2} \\ {w}_{n - 1} - {d}_{n - 1 , n - 1} {}^{- 1} {a}_{n - 1 , n} {w}_{n} \\ {w}_{n}\end{matrix}\right)\end{matrix}$$

Considering recursively from both sides of Equation (23), the following equation is established.

$$z = {\left\{{w}_{i} - {\sum }_{j = i + 1}^{n} {d}_{i , i} {}^{- 1} {a}_{i , j} {q}_{j}\right\}}_{i = 1}^{n}$$

qⱼ represents a j-th element of a vector of a right side of Equation (24).

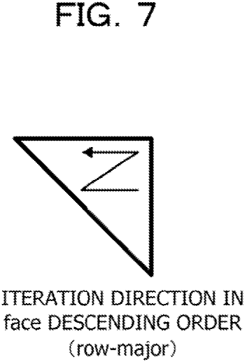

FIG. 7 illustrates an example of an iteration direction of the index face of the for loop 508. Only the non-zero elements of the matrix U_{A} by row-major are stored in upper of the equation 509 of the for loop 508.

In the for loop 508, the index face is changed from nFaces - 1 to 0 in descending order. nFaces represents the number of non-zero elements of the upper triangular matrix U_{A}. In this case, the index face represents an index for accessing the non-zero element of the matrix U_{A} by row-major.

For a sparse matrix in the LDU format, it is assumed that a position of the non-zero element of the matrix L_{A} and a position of the non-zero element of the matrix U_{A} are symmetric with respect to a diagonal element. Therefore, the fact that an element of the i-th row and the j-th column of the matrix L_{A} is not 0 is equivalent to the fact that an element of the j-th row and the i-th column of the matrix U_{A} is not 0.

Accordingly, in the same manner as in the case of the for loop 504 and the for loop 506, when i = l[face] and j = u[face], wA[l[face]] of the left side in the equation 509 of the for loop 508 corresponds to zᵢ of the left side of Equation (24). rD[l[face]] of the right side of the equation 509 corresponds to d_{i,i}⁻¹ of the second term of the right side of Equation (24), upper[face] corresponds to a_{i,j}, and wA[u[face]] corresponds to qⱼ. Therefore, it may be seen that the equation 509 represents the subtraction of the second term of the right side of Equation (24).

In the transposed version of the precondition in FIG. 5B, M^{-T} is used instead of M⁻¹. M^{-T} may be described by the following equation.

$$\begin{matrix}{\text{M}}^{- \text{T}} = {\left(\left({\text{L}}_{\text{A}} + \text{D}\right) {\text{D}}^{- 1} \left(\text{D} + {\text{U}}_{\text{A}}\right)\right)}^{- \text{T}} \\ = {\left({\left(\text{D} + {\text{U}}_{\text{A}}\right)}^{- 1} \text{D} {\left({\text{L}}_{\text{A}} + \text{D}\right)}^{- 1}\right)}^{\text{T}} \\ = {\left({\text{L}}_{\text{A}} + \text{D}\right)}^{- \text{T}} {\text{D}}^{\text{T}} {\left(\text{D} + {\text{U}}_{\text{A}}\right)}^{- \text{T}} \\ = {\left(\text{D} + {\text{U}}_{\text{AT}}\right)}^{- 1} \text{D} {\left({\text{L}}_{\text{AT}} + \text{D}\right)}^{- 1}\end{matrix}$$

AT in Equation (31) represents the transposed matrix A^{T} of the matrix A. According to Equation (31), in the precondition of the transposed version, the matrix A^{T} is accessed by switching between application and non-application of losort between forward substitution and backward substitution and switching between upper and lower.

Substitution is performed for each row in Equation (16), Equation (17), Equation (22), and Equation (23). Meanwhile, after the calculation of the i-th row is completed, even when all the j-th rows in which j > i (forward substitution) or j < i (backward substitution) is subtracted, the calculation order is maintained. Accordingly, in the precondition of the transposed version, in both forward substitution and backward substitution, access to a non-zero element is performed by column-major.

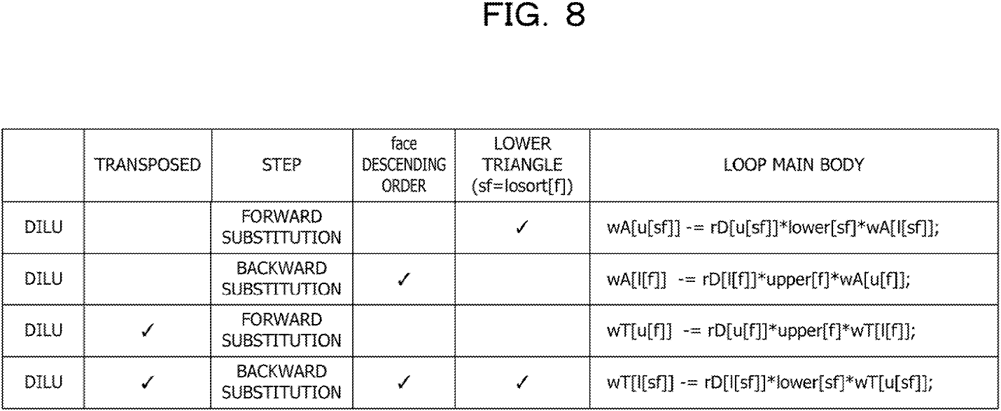

FIG. 8 illustrates an example of 4 substitution processes included in a DILU precondition. Transposition indicates whether or not the process is a process of a transposed version. A check mark for transposition indicates a process of the transposed version, and a no-check mark indicates that the process is not a process of the transposed version. A step indicates which of forward substitution and backward substitution is performed.

A face descending order indicates in which order face is changed in ascending order or descending order, in a for loop. The check mark in a face descending order indicates that face is changed in descending order, and the no-check mark indicates that face is changed in ascending order.

A lower triangle indicates which one of the lower triangular matrix L_{A} and the upper triangular matrix U_{A} is used. The check mark of the lower triangular indicates that the lower triangular matrix L_{A} is used, and the no-check mark indicates that the upper triangular matrix U_{A} is used.

A loop main body indicates a calculation equation of subtraction and substitution included in a for loop. For the sake of simplicity, face is denoted by f, and sface is denoted by sf. In the following description, the same notation may be also used. wT represents a precondition residual M^{-T}(b - A^{T}xᵢ).

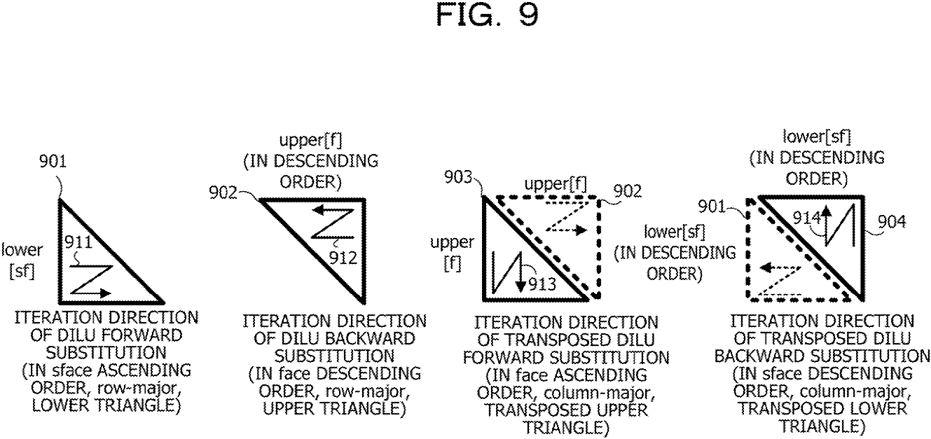

FIG. 9 illustrates an example of an iteration direction in 4 substitution processes illustrated in FIG. 8. DILU forward substitution represents forward substitution that is not a transposed version, and DILU backward substitution represents backward substitution that is not a transposed version. Transposed DILU forward substitution represents forward substitution of a transposed version, and transposed DILU backward substitution represents backward substitution of a transposed version.

A triangle 901 represents a lower triangular portion of the lower triangular matrix L_{A}, and a triangle 902 represents an upper triangular portion of the upper triangular matrix U_{A}. A triangle 903 represents a triangle obtained by transposing the triangle 902 (transposed upper triangle), and a triangle 904 represents a triangle obtained by transposing the triangle 901 (transposed lower triangle).

The lower triangular matrix L_{A} is used in DILU forward substitution, and the iteration direction is a direction indicated by an arrow 911. In this case, a non-zero element in the triangle 901 is accessed by row-major. Ascending order of sface indicates that ascending order of face and sf = losort[f] are applied.

The upper triangular matrix U_{A} is used in DILU backward substitution, and the iteration direction is a direction indicated by an arrow 912. In this case, face descending order is applied, and a non-zero element in the triangle 902 is accessed by row-major.

The upper triangular matrix U_{A} is used in transposed DILU forward substitution, and the iteration direction is a direction indicated by an arrow 913. In this case, face ascending order is applied, and a non-zero element in the triangle 903 is accessed in column-major.

The lower triangular matrix L_{A} is used in transposed DILU backward substitution, and the iteration direction is a direction indicated by an arrow 914. In this case, a non-zero element in the triangle 904 is accessed by column-major. sface descending order indicates that face descending order and sf = losort[f] are applied.

Hereinafter, a DIC precondition will be described. Since the matrix A is a symmetric matrix in the DIC precondition, A^{T} = A is obtained. In this case, since lower[sf] = upper[sf] is established, the equation 507 in FIG. 5B may be transformed as follows, in forward substitution of the DIC precondition.

$$\text{wA} \left[\text{u} \left[\text{sf}\right]\right] - = \text{rD} \left[\text{u} \left[\text{sf}\right]\right] * \text{upper} \left[\text{sf}\right] * \text{wA} \left[\text{l} \left[\text{sf}\right]\right]$$

After the calculation of the i-th row is completed, even when all the j-th rows in which j > i (forward substitution) or j < i (backward substitution) is subtracted, the calculation order is maintained. Therefore, Equation (32) may be modified as follows.

$$\text{wA} \left[\text{u} \left[\text{f}\right]\right] - = \text{rD} \left[\text{u} \left[\text{f}\right]\right] * \text{upper} \left[\text{f}\right] * \text{wA} \left[\text{l} \left[\text{f}\right]\right]$$

By using Equation (33), random access by losort is avoided, and memory access to upper, l, and u is made efficient. By not using lower, a memory use amount is reduced.

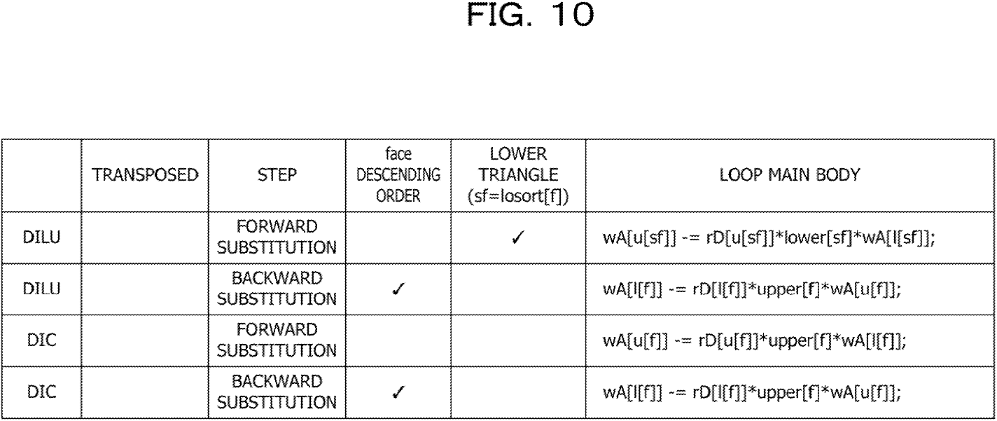

FIG. 10 illustrates an example of a substitution process included in a DILU precondition and a DIC precondition. Equation (33) is used in forward substitution in the DIC precondition, and the same calculation equation as backward substitution in the DILU precondition is used in backward substitution in the DIC precondition.

In the calculation equation of the loop main body illustrated in FIGS. 8 and 10, a value is read from wA or wT of the right side and a value is written to wA or wT of the left side, so that there is data dependency within the loop. Graph coloring is used as a method for parallelization of a loop process in which such data dependency exists.

For example, in forward substitution of the DIC precondition illustrated in FIG. 10, upper is included in the loop main body. In this case, by color-coding the non-zero elements of the upper triangular matrix U_{A} by graph coloring, the loop process may be parallelized without impairing the data dependency.

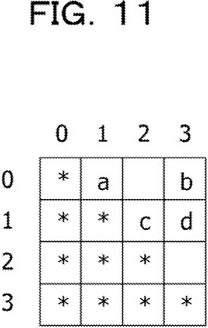

FIG. 11 illustrates an example of the upper triangular matrix U_{A}. The matrix U_{A} in FIG. 11 is a matrix having 4 rows and 4 columns, and row positions and column positions are represented by 0 to 3. Non-zero elements of the matrix U_{A} are a, b, c, and d. In this case, nFaces = 4, and upper, u, and l are as follows.

upper = [a, b, c, d], u = [1, 3, 2, 3], l = [0, 0, 1, 1]

As graph coloring of a matrix, column coloring or row coloring is used. In column coloring, each vertex of the colored graph is associated with each column, and in row coloring, each vertex of the colored graph is associated with each row.

For example, in graph coloring based on “A Nodal Numbering Scheme” described in E. Cuthill and J. McKee, “REDUCING THE BANDWIDTH OF SPARSE SYMMETRIC MATRICES”, In Proceedings of the 1969 24th national conference, Association for Computing Machinery, August 1969, pages 157-172, a vertex having no end point of an edge and a vertex adjacent only to a reached vertex are colored one by one. Column coloring is used for parallelization of forward substitution in the DIC precondition, and row coloring is used for parallelization of backward substitution in the DIC precondition.

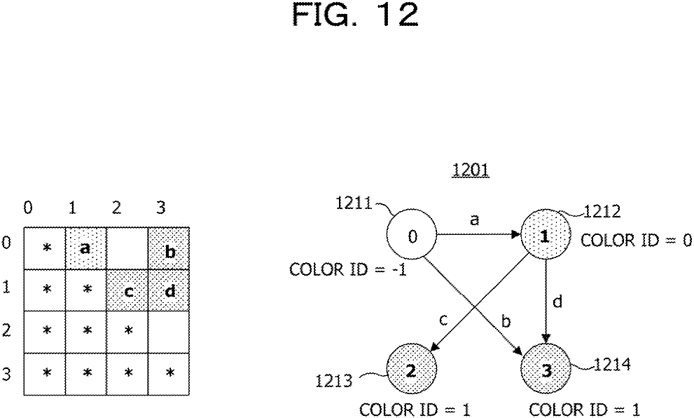

FIG. 12 illustrates an example of column coloring in the upper triangular matrix U_{A} illustrated in FIG. 11. First, the upper triangular matrix U_{A} is regarded as an adjacency matrix, and the upper triangular matrix U_{A} is converted into a directed graph 1201. A vertex 1211 to a vertex 1214 of the directed graph 1201 correspond to a column position 0 to a column position 3, respectively.

A non-zero element in an i-th row and a j-th column is associated with an edge extending from a vertex indicating a column position i to a vertex indicating a column position j. For example, a non-zero element a of row 0 and column 1 is associated with an edge extending from the vertex 1211 indicating the column position 0 to the vertex 1212 indicating the column position 1. In the same manner, b is associated with an edge extending from the vertex 1211 to the vertex 1214, c is associated with an edge extending from the vertex 1212 to the vertex 1213, and d is associated with an edge extending from the vertex 1212 to the vertex 1214.

An initial value of a color ID is -1, and the color ID is incremented by 1 every time coloring is performed. Since only a column that does not include a non-zero element corresponds to the color ID “-1” and the column is not used in the precondition, the color ID of the column used in the precondition starts with 0.

Since the vertex 1211 does not have an end point of an edge (end point of an arrow), the color ID “-1” is assigned to the vertex 1211. Next, the color ID “0” is assigned to the vertex 1212 reachable from the vertex 1211. Next, the color ID “1” is assigned to the vertex 1213 reachable from the vertex 1212 and the vertex 1214 reachable from the vertices 1211 and 1212.

Next, the color ID assigned to each vertex is assigned to a column position indicated by the vertex. For example, the color ID “0” of the vertex 1212 is assigned to the column position 1 indicated by the vertex 1212. In the same manner, the color ID “1” of the vertex 1213 is assigned to the column position 2, and the color ID “1” of the vertex 1214 is assigned to the column position 3. Therefore, a is colored with a color indicated by the color ID “0”, and b, c, and d are colored with a color indicated by the color ID “1”.

With column coloring, calculation using the non-zero element of one or a plurality of columns colored with the same color may be performed by using only a result of previously completed calculation. Therefore, there is no data dependency between the calculations using the non-zero elements of the same color, and these calculations may be performed in parallel.

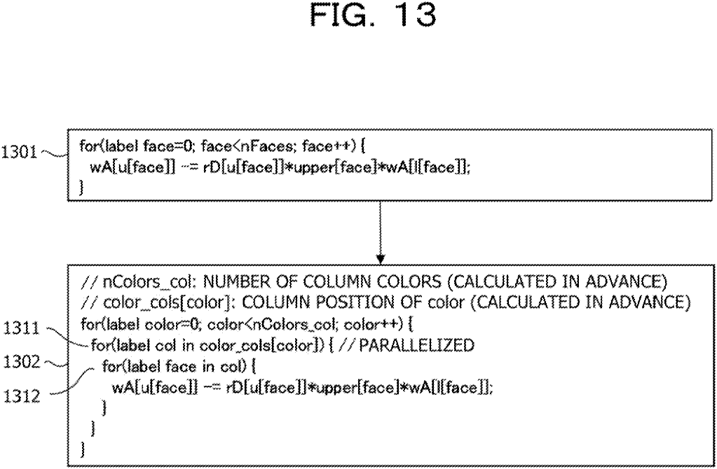

FIG. 13 illustrates an example of parallelization of forward substitution in a DIC precondition. A loop process 1301 represents forward substitution of the DIC precondition, and a loop process 1302 represents a process in which the loop process 1301 is parallelized by column coloring.

nColors_col of the loop process 1302 represents the number of colors used in column coloring (the number of column colors), and color represents a color ID. color_cols[color] represents a column position to which a color indicated by color is assigned. nColors_col and color_cols[color] are calculated in advance.

A for loop 1311 included in the loop process 1302 is parallelized. On the other hand, in an innermost for loop 1312, performance degradation is expected when parallelization is performed by using atomic add, and thus the for loop 1312 is processed by a sequential process.

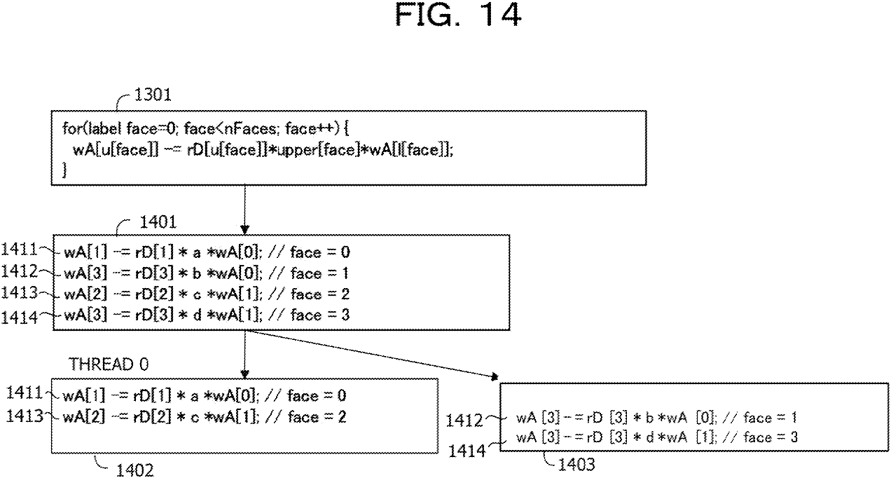

FIG. 14 illustrates an example of parallelization based on column coloring in FIG. 12. Since the color IDs of the columns used in the precondition are 0 and 1 in column coloring in FIG. 12, nColors_col = 2. In this case, color_cols is as follows.

color_cols[0] = [1], color_cols[1] = [2, 3]

When expanding the loop process 1301 in FIG. 13, a process 1401 results. The process 1401 includes an equation 1411 to an equation 1414. Among the equation 1411 to the equation 1414, the equation 1411 is a calculation equation using a non-zero element to which a color ID “0” is assigned, and the equation 1412 to the equation 1414 are calculation equations using non-zero elements to which a color ID “1” is assigned. Therefore, the calculations of the equation 1412 to the equation 1414 may be parallelized.

For example, in a case where the process 1401 is parallelized by using threads 0 and 1, a process 1402 may be allocated to the thread 0 and a process 1403 may be allocated to the thread 1. The process 1402 includes the equation 1411 and the equation 1413, and the process 1403 includes the equation 1412 and the equation 1414.

In the process 1402, the thread 0 executes the calculation of the equation 1413 after the calculation of the equation 1411 is completed. In the process 1403, the thread 1 executes the calculations of the equation 1412 and the equation 1414 after the calculation of the equation 1411 by the thread 0 is completed.

In this case, the calculations of the equation 1412 and the equation 1414 are executed in parallel with the calculation of the equation 1413. Therefore, the calculation equation is reduced from 4 rows to 3 rows, and the process 1401 is speeded up. In this manner, by allocating the calculation using the non-zero elements of the plurality of columns colored with the same color to different threads for each column, it is possible to easily parallelize forward substitution in the DIC precondition.

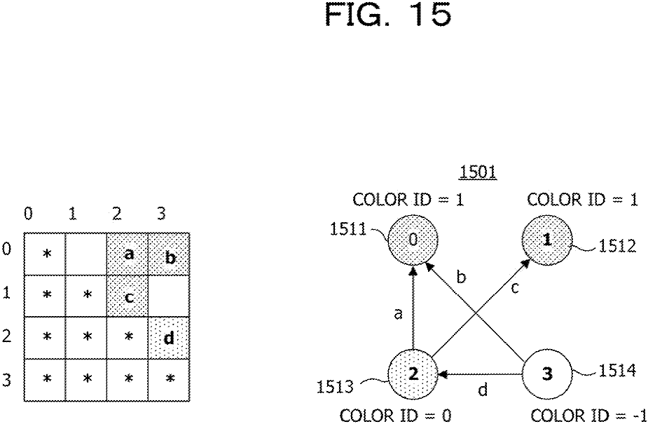

FIG. 15 illustrates an example of row coloring in the upper triangular matrix U_{A}. First, the upper triangular matrix U_{A} is regarded as an adjacency matrix, and the upper triangular matrix U_{A} is converted into a directed graph 1501. A vertex 1511 to a vertex 1514 of the directed graph 1501 respectively correspond to a row position 0 to a row position 3.

Unlike column coloring, in a case of row coloring, a non-zero element in an i-th row and a j-th column is associated with an edge extending from a vertex indicating the row position j to a vertex indicating the row position i. For example, the non-zero element a of row 0 and column 2 is associated with an edge extending from the vertex 1513 indicating a row position 2 to the vertex 1511 indicating a row position 0. In the same manner, b is associated with an edge extending from the vertex 1514 to the vertex 1511, c is associated with an edge extending from the vertex 1513 to the vertex 1512, and d is associated with an edge extending from the vertex 1514 to the vertex 1513.

An initial value of a color ID is -1, and the color ID is incremented by 1 every time coloring is performed. Since only a row that does not include a non-zero element corresponds to the color ID “-1” and the row is not used in the precondition, the color ID of the row used in the precondition starts with 0.

Since the vertex 1514 does not have an end point of an edge, the color ID “-1” is assigned to the vertex 1514. Next, the color ID “0” is assigned to the vertex 1513 reachable only from the vertex 1514. Next, the color ID “1” is assigned to the vertex 1512 reachable from the vertex 1513 and the vertex 1511 reachable from the vertex 1513 and the vertex 1514.

Next, the color ID assigned to each vertex is assigned to a row position indicated by the vertex. For example, the color ID “0” of the vertex 1513 is assigned to the row position 2 indicated by the vertex 1513. In the same manner, the color ID “1” of the vertex 1512 is assigned to the row position 1, and the color ID “1” of the vertex 1511 is assigned to the row position 0. Therefore, d is colored with a color indicated by the color ID “0”, and a, b, and c are colored with a color indicated by the color ID “1”.

With row coloring, calculation using the non-zero element of one or a plurality of rows colored with the same color may be performed by using only a result of previously completed calculation. Therefore, there is no data dependency between the calculations using the non-zero elements of the same color, and these calculations may be performed in parallel.

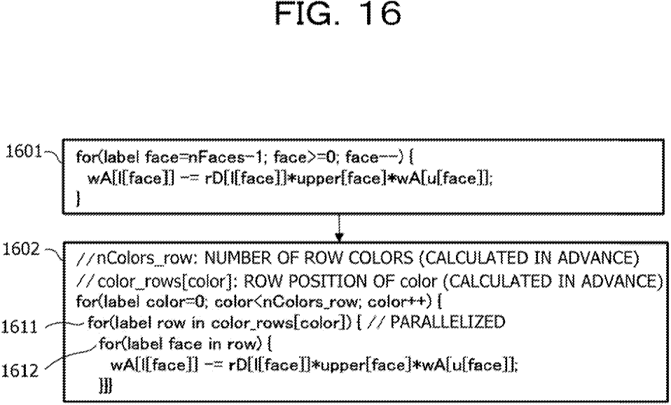

FIG. 16 illustrates an example of parallelization of backward substitution in a DIC precondition. A loop process 1601 represents backward substitution in the DIC precondition, and a loop process 1602 represents a process in which the loop process 1601 is parallelized by row coloring.

nColors_row in the loop process 1602 represents the number of colors (the number of row colors) used in row coloring, and color represents a color ID. color_rows[color] represents a row position to which a color indicated by color is assigned. nColors_row and color_rows[color] are calculated in advance.

A for loop 1611 included in the loop process 1602 is parallelized. In a case of row coloring, a starting point and an end point of an edge of a graph are certainly in descending order of row positions, and an innermost for loop 1612 has no data dependency. Therefore, the calculation is executed in ascending order in the for loop 1611 and the for loop 1612.

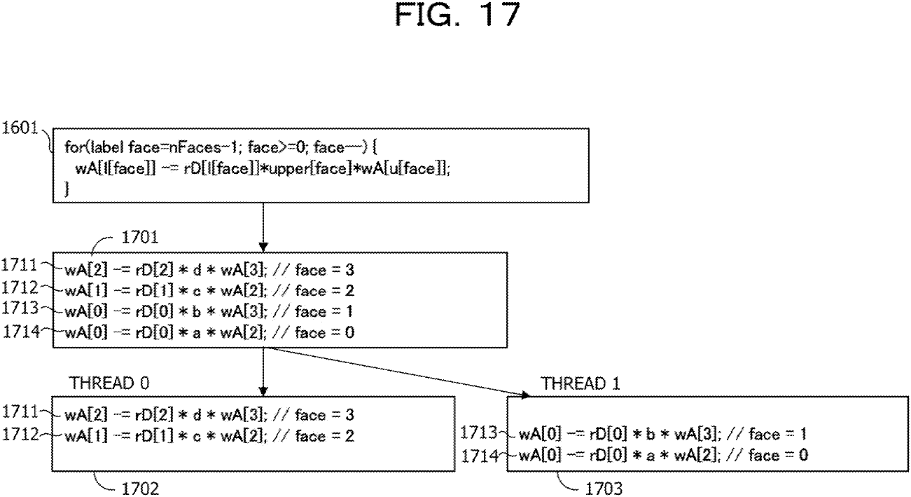

FIG. 17 illustrates an example of parallelization based on row coloring in FIG. 15. In row coloring in FIG. 15, the non-zero elements of the matrix U_{A} are a, b, c, and d, so that nFaces = 4. Since the color IDs of the rows used in the precondition are 0 and 1, nColors_row = 2. In this case, upper, u, l, and color_rows are as follows.

upper = [a, b, c, d], u = [2, 3, 2, 3], l = [0, 0, 1, 2], color_rows[0] = [2], color_rows[1] = [1, 0]

When expanding the loop process 1601 in FIG. 16, a process 1701 results. The process 1701 includes an equation 1711 to an equation 1714. Among the equation 1711 to the equation 1714, the equation 1711 is a calculation equation using a non-zero element to which a color ID “0” is assigned, and the equation 1712 to the equation 1714 are calculation equations using non-zero elements to which a color ID “1” is assigned. Therefore, the calculations of the equation 1712 to the equation 1714 may be parallelized.

For example, in a case where the process 1701 is parallelized by using the threads 0 and 1, a process 1702 may be allocated to the thread 0 and a process 1703 may be allocated to the thread 1. The process 1702 includes the equation 1711 and the equation 1712, and the process 1703 includes the equation 1713 and the equation 1714.

In the process 1702, the thread 0 executes the calculation of the equation 1712 after the calculation of the equation 1711 is completed. In the process 1703, the thread 1 executes the calculations of the equation 1713 and the equation 1714 after the calculation of the equation 1711 by the thread 0 is completed.

In this case, the calculations of the equation 1713 and the equation 1714 are executed in parallel with the calculation of the equation 1712. Therefore, the calculation equation is reduced from 4 rows to 3 rows, and the process 1701 is speeded up. In this manner, by allocating the calculation using the non-zero elements of the plurality of rows colored with the same color to different threads for each row, it is possible to easily parallelize backward substitution in the DIC precondition.

FIG. 18 illustrates an example of loop processes of a DIC precondition and a DILU precondition. Forward substitution and backward substitution in the DILU precondition in FIG. 18 have the same manner as forward substitution and backward substitution in FIG. 8. Forward substitution and backward substitution in the DIC precondition in FIG. 18 have the same manner as forward substitution and backward substitution in FIG. 10.

The following equation is used in calculation of D⁻¹ in the DIC precondition.

$$\text{rD} \left[\text{u} \left[\text{f}\right]\right] - = \text{upper} \left[\text{f}\right] * \text{upper} \left[\text{f}\right] / \text{rD} \left[\text{l} \left[\text{f}\right]\right]$$

The following equation is used in calculation of D⁻¹ in the DILU precondition.

$$\text{rD} \left[\text{u} \left[\text{f}\right]\right] - = \text{upper} \left[\text{f}\right] * \text{lower} \left[\text{f}\right] / \text{rD} \left[\text{l} \left[\text{f}\right]\right]$$

An array to be calculated in the D⁻¹ calculations of the DIC precondition and the DILU precondition is rD. An array to be calculated in forward substitution and backward substitution in the DIC precondition and the DILU precondition is wA. An array to be calculated in forward substitution of a transposed version and backward substitution of a transposed version in the DILU precondition is wT.

In all the loop processes in FIG. 18, similar data dependencies exist for the array to be calculated. Therefore, parallelization based on graph coloring may be applied to these loop processes.

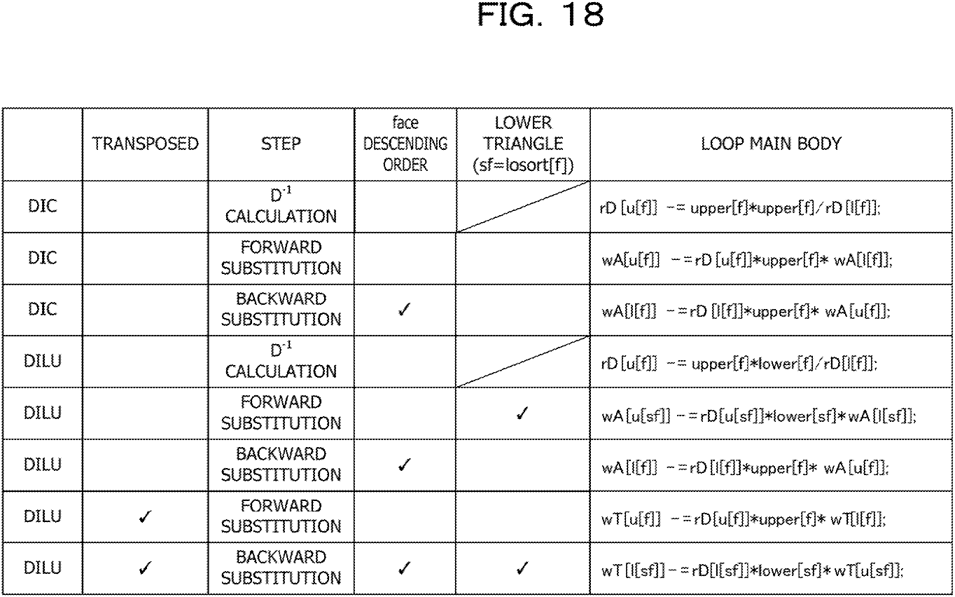

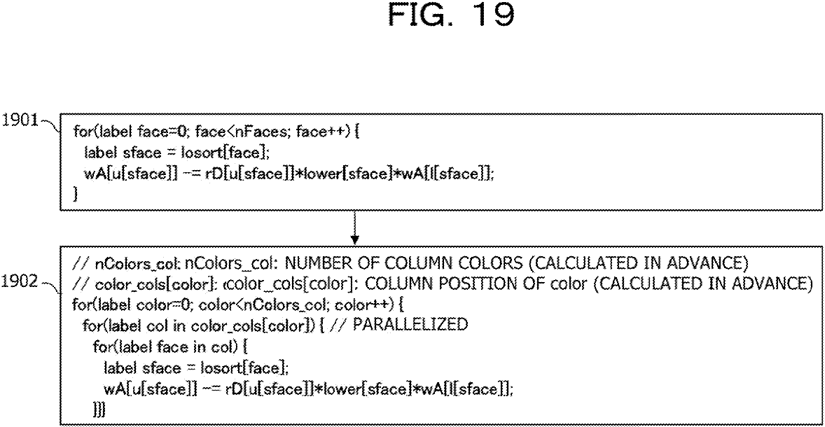

FIG. 19 illustrates an example of parallelization of forward substitution in a DILU precondition. A loop process 1901 represents forward substitution of the DILU precondition, and a loop process 1902 represents a process in which the loop process 1901 is parallelized by column coloring. In the same manner as the case of forward substitution in the DIC precondition, forward substitution in the DILU precondition may be parallelized by column coloring.

A reason why the same column coloring as in forward substitution in the DIC precondition may be used in forward substitution in the DILU precondition will be described.

As illustrated in FIG. 18, in forward substitution in the DILU precondition, sf = losort[f] is used as an index indicating a non-zero element of the upper triangular matrix U_{A}, unlike forward substitution in the DIC precondition.

First, it is assumed that f1 < f2 and u[f1] = l[f2] are established for the index f1 and the index f2 indicating the non-zero elements of the upper triangular matrix U_{A}. In this case, data dependency exists in a calculation order of f1 and f2.

It is assumed that losort[f1] > losort[f2] is established. In this case, the order of calculating f1 and f2 is reversed due to the application of losort, and the data dependency does not exist. Since losort corresponds to the lexicographic sort of the upper u and the lower l, any one of the following relationships is established by losort[f1] > losort[f2].

$$\text{u} \left[\text{f1}\right] > \text{u} \left[\text{f2}\right]$$

$$\text{u} \left[\text{f1}\right] = \text{u} \left[\text{f2}\right] \text{and l} \left[\text{f1}\right] > \text{l} \left[\text{f2}\right]$$

From Equation (36) and u[f1] = l[f2], l[f2] > u[f2] is established, and from Equation (37) and u[f1] = l[f2], l[f1] > u[f1] is established. Meanwhile, l[f2] > u[f2] contradicts that f2 indicates the non-zero element of the upper triangular matrix U_{A}, and l[f1] > u[f1] contradicts that f1 indicates the non-zero element of the upper triangular matrix U_{A}. Therefore, the order of calculating f1 and f2 is not changed due to the application of losort, and the data dependency exists even after the application of losort.

Since inverse transform of losort corresponds to the lexicographic sort of the upper l and the lower u, a similar conclusion is drawn also in the opposite case. Therefore, it is a necessary and sufficient condition that the data dependency exists in the calculation using 2 non-zero elements before the application of losort and the data dependency exists in the calculation using 2 non-zero elements after the application of losort.

From the above description, it may be seen that the same column coloring as in forward substitution of the DIC precondition before the application of losort may be used in forward substitution of the DILU precondition after the application of losort.

In the same manner, backward substitution in the DILU precondition, forward substitution in the transposed version of the DILU precondition, and backward substitution in the transposed version of the DILU precondition may be parallelized by graph coloring.

FIG. 20 illustrates an example of a calculation process based on graph coloring. An upper triangular matrix in FIG. 20 is a matrix having 6 rows and 6 columns, and row positions and column positions are represented by 0 to 5. Non-zero elements of the upper triangular matrix are a, b, c, d, e, f, g, and h.

In this example, a color ID “0” is assigned to the column position 1, a color ID “1” is assigned to the column positions 2 and 4, and a color ID “2” is assigned to the column positions 3 and 5. Therefore, a is colored with a color indicated by the color ID “0”, c, d, and f are colored with a color indicated by the color ID “1”, and b, e, g, and h are colored with a color indicated by the color ID “2”.

A calculation 2011 is a calculation using a at the column position 1, a calculation 2012-1 is a calculation using d at the column position 2, and a calculation 2012-2 is a calculation using c and f at the column position 4. A calculation 2013-1 is a calculation using b, e, and g at the column position 3, and a calculation 2013-2 is a calculation using h at the column position 5. Therefore, the calculation 2012-1 and the calculation 2012-2 are calculations using the non-zero elements of the same color, and the calculation 2013-1 and the calculation 2013-2 are calculations using the non-zero elements of the same color.

In a case where these calculations are executed by using only the thread 0, the thread 0 executes the calculation 2011, the calculation 2012-1, the calculation 2012-2, the calculation 2013-1, and the calculation 2013-2 in time series.

In a case where these calculations are executed by using the thread 0 and the thread 1, the thread 0 executes the calculation 2011, the calculation 2012-1, and the calculation 2013-1 in time series. The thread 1 executes the calculation 2012-2 in parallel with the calculation 2012-1, and executes the calculation 2013-2 in parallel with the calculation 2013-1.

In a case where a plurality of threads are used, a synchronization process is inserted between calculations using non-zero elements of different colors in order to ensure an order of calculations in which data dependency exists. In this example, after the calculation 2011 is completed, a synchronization process 2021 is performed between the thread 0 and the thread 1, and after the calculation 2012-1 and the calculation 2012-2 are completed, a synchronization process 2022 is performed between the thread 0 and the thread 1.

Although a calculation time is reduced in a case where the thread 0 and the thread 1 are used as compared with the case where only the thread 0 is used, overhead for the synchronization process 2021 and the synchronization process 2022 is generated. In this manner, in the calculation process based on graph coloring, the calculation time is increased as the number of threads decreases, and the overhead of the synchronization process is increased as the number of threads increases.

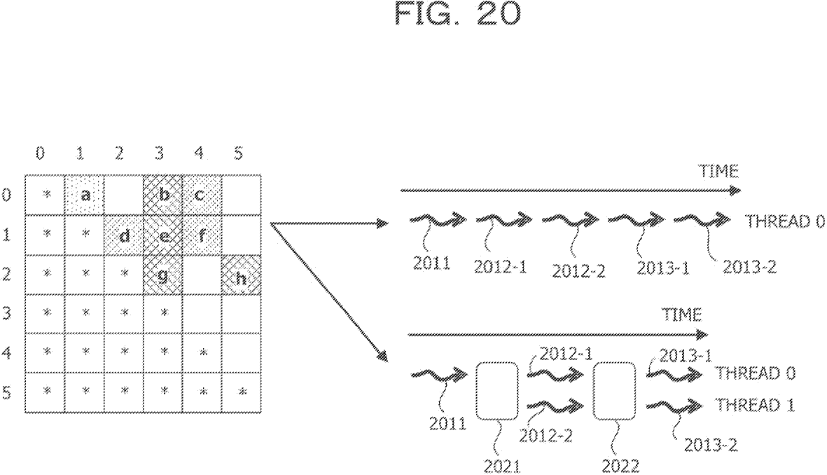

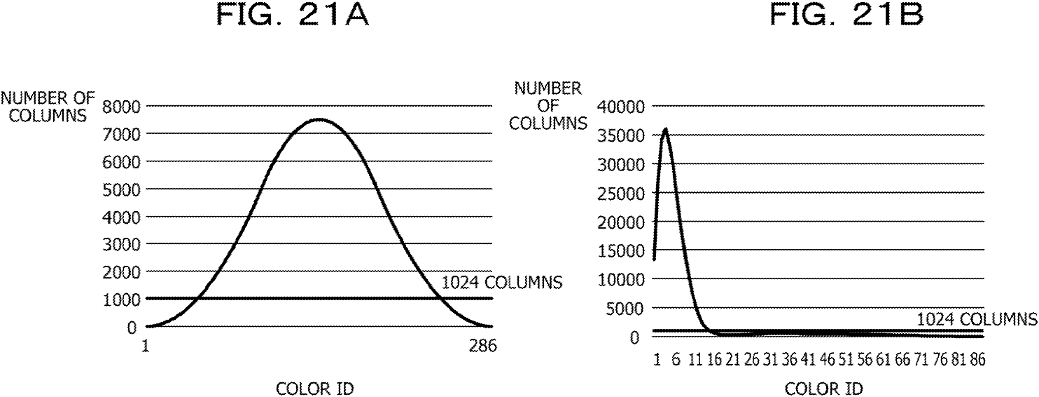

FIGS. 21A and 21B illustrate an example of the number of columns for each color in a fluid analysis simulation. A horizontal axis represents a color ID, and a vertical axis represents the number of columns to which the same color ID is assigned (the number of columns). A maximum number of threads per block of a GPU used for calculation is 1024. In this case, it is possible to execute the calculation using a maximum of 1024 columns in one block.

The block represents a logical collection of threads. The maximum number of threads per block may also be referred to as a block size. The block is an example of a group of threads, and a block size is an example of a group size.

FIG. 21A illustrates an example of a change in the number of columns in a fluid analysis simulation for calculating a pressure in a 100×100×100 cubic lattice. FIG. 21B illustrates an example of a change in the number of columns in a fluid analysis simulation for calculating a pressure of a 290,000 unstructured lattice.

As seen from FIGS. 21A and 21B, a peak of the number of columns is steep, and the number of columns for each color is greatly increased and decreased. Therefore, in order to set an optimum number of threads in accordance with the number of columns for each color, it is desirable to perform scheduling of an appropriate number of threads.

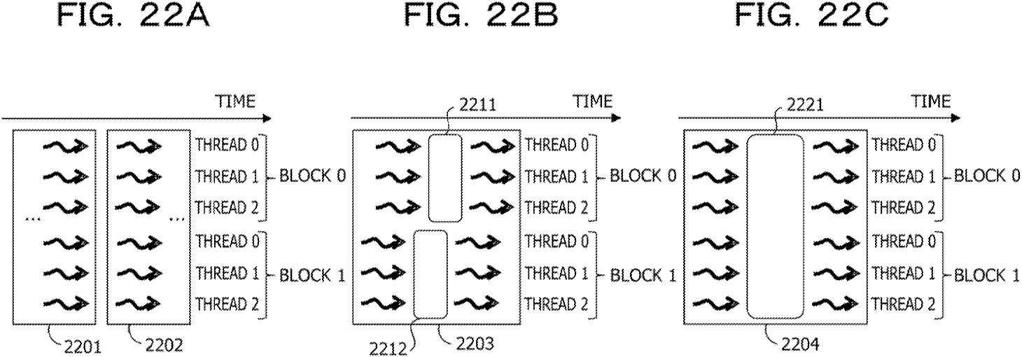

FIGS. 22A to 22C illustrate an example of a method for synchronization between threads in a GPU environment. FIG. 22A illustrates an example of stream synchronization. Each of a kernel 2201 and a kernel 2202 includes a block 0 and a block 1. The kernel represents a unit of calculations executed in time series by a stream of a GPU. The kernel may also be referred to as a kernel function. The block 0 includes threads 0 to 2, and the block 1 includes threads 0 to 2.

In stream synchronization, a synchronization process for all threads is executed between the kernel 2201 and the kernel 2202 which are continuously executed. In this case, since the following kernel 2202 is activated after the preceding kernel 2201 is once completed, an activation cost of the kernel 2202 is increased.

FIG. 22B illustrates an example of intra-block synchronization. A kernel 2203 includes a block 0 and a block 1. In intra-block synchronization, a synchronization process 2211 for all threads in the block 0 and a synchronization process 2212 for all threads in the block 1 are separately executed. In this case, the number of synchronized threads is limited to a block size. Intra-block synchronization is an example of intra-group synchronization.

FIG. 22C illustrates an example of inter-block synchronization. A kernel 2204 includes a block 0 and a block 1. In inter-block synchronization, a synchronization process 2221 for all threads included in the block 0 and the block 1 in the kernel 2204 is executed. In this case, a cost of the synchronization process is higher than a cost of intra-block synchronization. Inter-block synchronization is an example of inter-group synchronization.

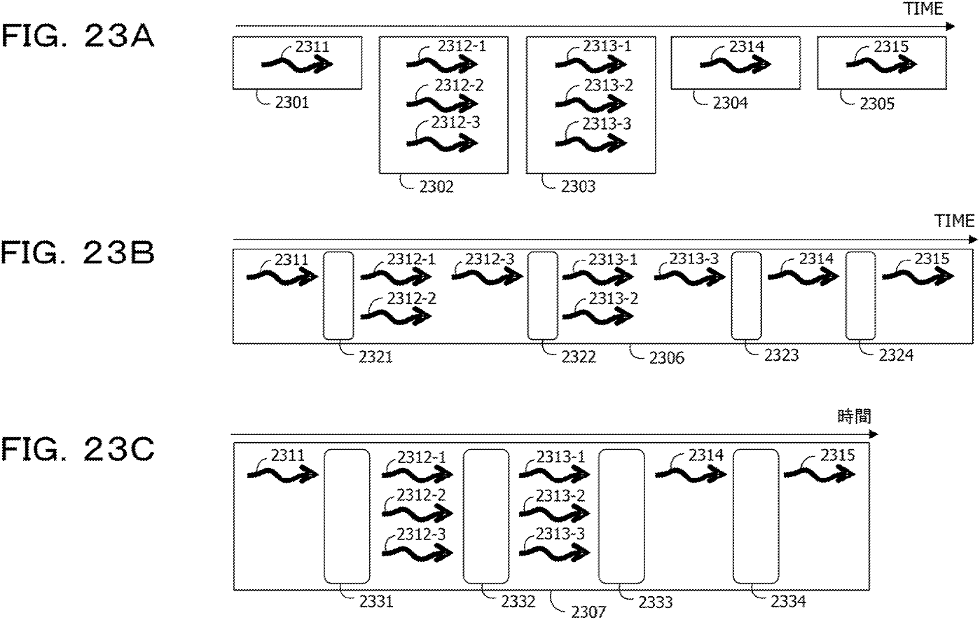

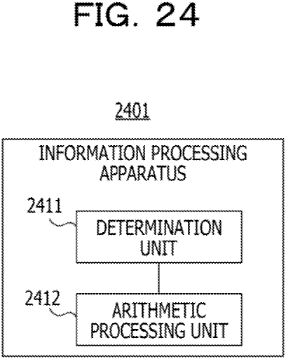

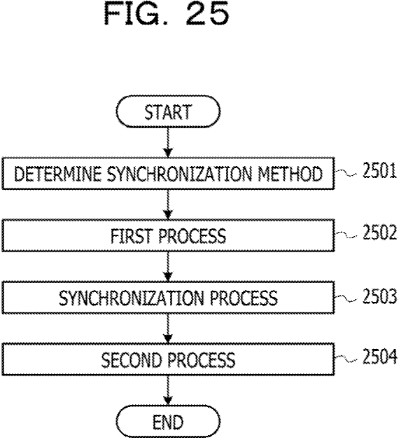

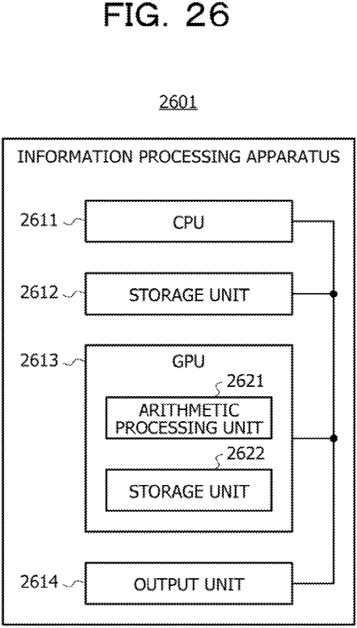

FIGS. 23A to 23C illustrate an example of a calculation process to which the synchronization method illustrated in FIGS. 22A to 22C is applied. In this example, 5 color IDs are used.

A calculation 2311 is a calculation using a non-zero element of a column to which the color ID “0” is assigned. A calculation 2312-1 to a calculation 2312-3 are calculations using non-zero elements of a column to which the color ID “1” is assigned. A calculation 2313-1 to a calculation 2313-3 are calculations using non-zero elements of a column to which the color ID “2” is assigned. A calculation 2314 is a calculation using a non-zero element of a column to which the color ID “3” is assigned. A calculation 2315 is a calculation using a non-zero element of a column to which the color ID “4” is assigned.

FIG. 23A illustrates an example of a calculation process to which stream synchronization is applied. A kernel 2301 executes the calculation 2311. A kernel 2302 executes the calculation 2312-1 to the calculation 2312-3 in parallel. A kernel 2303 executes the calculation 2313-1 to the calculation 2313-3 in parallel. A kernel 2304 executes the calculation 2314. A kernel 2305 executes the calculation 2315.

In a case where stream synchronization is applied, a new kernel is activated every time a color is switched, and thus the activation cost of the kernel is increased.

FIG. 23B illustrates an example of a calculation process to which intra-block synchronization is applied. A kernel 2306 includes 1 block, and a block size is 2.

Among 2 threads in the block, one thread executes the calculation 2311, the calculation 2312-1, the calculation 2312-3, the calculation 2313-1, the calculation 2313-3, the calculation 2314, and the calculation 2315 in time series. Another thread executes the calculation 2312-2 in parallel with the calculation 2312-1, and executes the calculation 2313-2 in parallel with the calculation 2313-1.

After the calculation 2311 is completed, a synchronization process 2321 is performed between the 2 threads, and after the calculation 2312-1 to the calculation 2312-3 are completed, the synchronization process 2322 is performed between the 2 threads. After the calculation 2313-1 to the calculation 2313-3 are completed, a synchronization process 2323 is performed between the 2 threads, and after the calculation 2314 is completed, a synchronization process 2324 is performed between the 2 threads.

In a case where intra-block synchronization is applied, when the number of columns of the same color exceeds the block size, the calculation is expanded in a time direction, and thus a calculation time is increased.

FIG. 23C illustrates an example of a calculation process to which inter-block synchronization is applied. A kernel 2307 includes 2 blocks, and has a block size of 2.

One thread included in one block of the 2 blocks executes the calculation 2311, the calculation 2312-1, the calculation 2313-1, the calculation 2314, and the calculation 2315 in time series. Another thread executes the calculation 2312-2 in parallel with the calculation 2312-1, and executes the calculation 2313-2 in parallel with the calculation 2313-1.

One thread included in the other block executes the calculation 2312-3 in parallel with the calculation 2312-1 and the calculation 2312-2, and executes the calculation 2313-3 in parallel with the calculation 2313-1 and the calculation 2313-2.

After the calculation 2311 is completed, a synchronization process 2331 is performed between the 3 threads, and after the calculation 2312-1 to the calculation 2312-3 are completed, a synchronization process 2332-is performed between the 3 threads. After the calculation 2313-1 to the calculation 2313-3 are completed, a synchronization process 2333 is performed between the 3 threads, and after the calculation 2314 is completed, a synchronization process 2334 is performed between the 3 threads.

In a case where inter-block synchronization is applied, the number of threads is redundant in calculation of a color having a small number of columns, and thus the cost of the synchronization process is increased.

In this manner, since application conditions and costs of the synchronization process vary depending on the synchronization method between the threads in the GPU environment, it is desirable to use different synchronization methods so as to improve efficiency of the entire calculation process.

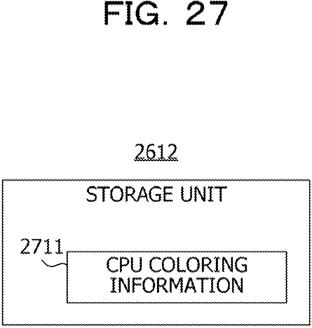

FIG. 24 illustrates an example of a functional configuration of an information processing apparatus (computer) according to the embodiment. An information processing apparatus 2401 illustrated in FIG. 24 includes a determination unit 2411 and an arithmetic processing unit 2412.

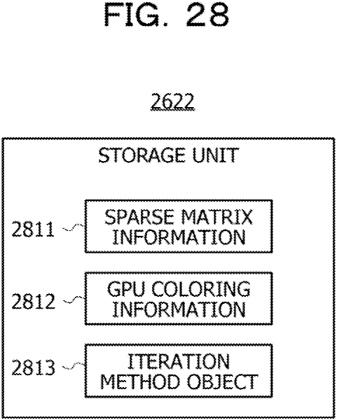

FIG. 25 is a flowchart illustrating an example of an arithmetic process performed by the information processing apparatus 2401 in FIG. 24.

The determination unit 2411 uses each of a plurality of processes included in a matrix process as a first process, and uses a process next to the first process as a second process. First, the determination unit 2411 determines a synchronization method for one or a plurality of processing units in which elements of a first portion of a matrix are processed in parallel in the first process (step 2501). At this time, the determination unit 2411 determines the synchronization method, based on the number of the one or the plurality of processing units that process the elements of the first portion of the matrix in parallel and the number of one or a plurality of processing units that process the elements of a second portion of the matrix in parallel in the second process.

Next, the arithmetic processing unit 2412 executes the first process by using the one or the plurality of processing units that process the elements of the first portion of the matrix in parallel (step 2502). Next, the arithmetic processing unit 2412 executes the synchronization process for the one or the plurality of processing units in which the elements of the first portion of the matrix are processed in parallel by using the determined synchronization method (step 2503). Next, the arithmetic processing unit 2412 executes the second process by using the one or the plurality of processing units for processing the elements of the second portion of the matrix in parallel (step 2504).

With the information processing apparatus 2401 illustrated in FIG. 24, processing efficiency of the parallel process using the matrix may be improved.

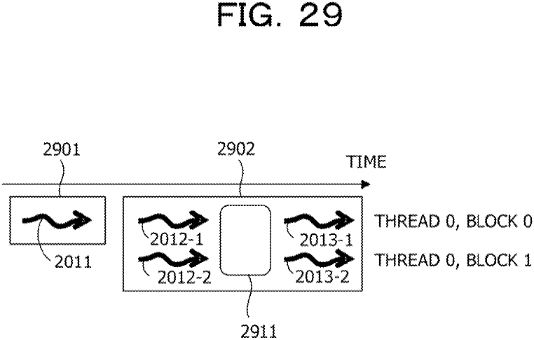

FIG. 26 illustrates a specific example of the information processing apparatus 2401 illustrated in FIG. 24. An information processing apparatus 2601 illustrated in FIG. 26 includes a central processing unit (CPU) 2611, a storage unit 2612, a GPU 2613, and an output unit 2614. The GPU 2613 includes an arithmetic processing unit 2621 and a storage unit 2622. The CPU 2611 and the arithmetic processing unit 2621 correspond to the determination unit 2411 and the arithmetic processing unit 2412 in FIG. 24, respectively.

The information processing apparatus 2601 obtains a solution of a simultaneous linear equation of Equation (2) by an iteration method, in various numerical calculations such as a fluid analysis simulation, a climate simulation, and a molecular dynamics simulation in fields such as material science and biochemistry. For example, the fluid analysis simulation may be a simulation in which a steady analysis of a fluid is performed by using a Pressure-Implicit with Splitting of Operators (PISO) method. In this case, the vector x in Equation (2) represents a physical quantity. x may be a vector representing a pressure or a velocity.

As the iteration method, for example, a PCG method or a PBiCG method is used. A DIC precondition is used in the PCG method, and a DILU precondition is used in the PBiCG method. According to the physical quantity represented by x, either the PCG method or the PBiCG method may be selected.

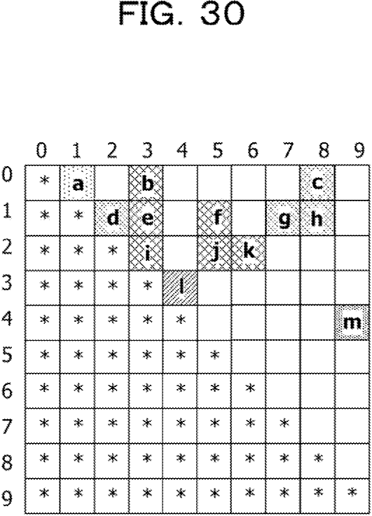

FIG. 27 illustrates an example of information stored in the storage unit 2612 in FIG. 26. The storage unit 2612 illustrated in FIG. 27 stores CPU coloring information 2711 of each of the upper triangular matrix U_{A} and the lower triangular matrix L_{A}. The CPU coloring information 2711 includes CPU column coloring information and CPU row coloring information. The CPU column coloring information includes nColors, maxThreads, threads, and kernels.

nColors represents the number of colors used in column coloring. threads is an array representing the number of columns for each color. maxThreads represents the maximum value of the number of columns for each color. kernels is an array representing activation information for each kernel used in the iteration method.

The activation information of the kernel includes a start offset and a flag. The start offset represents an index of threads corresponding to a color of a non-zero element used for calculation by a thread at a time of kernel activation. The flag indicates whether or not the number of threads in the kernel is larger than a block size. For simplification of implementation, the start offset of the last element of the kernels is set to nColors, and the flag is set to not applicable (N/A).

The CPU row coloring information also includes information in the same manner as the CPU column coloring information. nColors of the CPU row coloring information represents the number of colors used in row coloring, threads represents the number of rows for each color, and maxThreads represents the maximum value of the number of rows for each color.

FIG. 28 illustrates an example of information stored in the storage unit 2622 in the GPU 2613 in FIG. 26. The storage unit 2622 in FIG. 28 stores sparse matrix information 2811, GPU coloring information 2812 of each of the upper triangular matrix U_{A} and the lower triangular matrix L_{A}, and an iteration method object 2813.

The sparse matrix information 2811 is information of a sparse matrix in an LDU format, and includes diag, upper, lower, u, l, ownerStart, losortStart, and losort.

diag is an array representing diagonal elements of a coefficient matrix A, upper is an array representing a non-zero element of the upper triangular matrix U_{A} in row-major, and lower is an array representing a non-zero element of the lower triangular matrix L_{A} in column-major.

u is an array representing column positions of non-zero elements of the upper triangular matrix U_{A}, and l is an array representing row positions of non-zero elements of the upper triangular matrix U_{A}. For the sparse matrix in the LDU format, it is assumed that a position of the non-zero element of the upper triangular matrix U_{A} and a position of the non-zero element of the lower triangular matrix L_{A} are symmetric with respect to the diagonal element. Therefore, u represents the row position of the non-zero element of the lower triangular matrix L_{A}, and l represents the column position of the non-zero element of the lower triangular matrix L_{A}.

ownerStart is an array representing an index of upper corresponding to the first non-zero element of each row in a case where the non-zero elements of the upper triangular matrix U_{A} are arranged in row-major. Each element in ownerStart corresponds to the number of non-zero elements included in a row above each row position.

losortStart is an array representing an index of lower corresponding to the first non-zero element of each column in a case where the non-zero elements of the upper triangular matrix U_{A} are arranged in column-major. Each element in losortStart corresponds to the number of non-zero elements included in a column on the left side of each column position.

losort is an array representing an index of upper corresponding to each non-zero element in a case where the non-zero elements of the upper triangular matrix U_{A} are arranged in column-major.

By using such sparse matrix information 2811, it is possible to read information on the non-zero element included in a specific column or row of the upper triangular matrix U_{A} or the lower triangular matrix L_{A} in an order of a constant number or in an order of the number of non-zero elements of the column or row. The information on the non-zero elements to be read are the number, the positions, and the values of the non-zero elements.

The GPU coloring information 2812 includes GPU column coloring information and GPU row coloring information. The GPU column coloring information includes sorted, starts, and threads.

sorted is an array representing column positions sorted in an order of colors, and starts is an array representing a start offset for each color in sorted. The start offset represents an index of sorted corresponding to the first column position to which each color is assigned. threads is an array in the same manner as threads of the CPU column coloring information.

The GPU row coloring information also includes information in the same manner as the GPU column coloring information. sorted in the GPU row coloring information represents row positions sorted in an order of colors, and starts represents an index of sorted corresponding to the first row position to which each color is assigned. threads is an array in the same manner as threads of the CPU row coloring information.

The iteration method object 2813 includes rD, rA, wA, rT, wT, and iteration method data. rD is an array representing a reciprocal of a diagonal element. rA is an array representing the residual b - Axᵢ, and wA is an array representing the precondition residual M⁻¹(b - Axᵢ). rT is an array representing a residual b - A^{T}xᵢ of a transposed version, and wT is an array representing the precondition residual M^{-T}(b - A^{T}xᵢ) of a transposed version. The iteration method data includes data such as the solution xᵢ in step i of the iteration method.

For example, in a case of the upper triangular matrix illustrated in FIG. 20, the sparse matrix information 2811 is as follows.

upper = [a, b, c, d, e, f, g, h], u = [1, 3, 4, 2, 3, 4, 3, 5], l = [0, 0, 0, 1, 1, 1, 2, 2], ownerStart = [0, 3, 6, 8, 8, 8, 8], losortStart = [0, 0, 1, 2, 5, 7, 8], losort = [0, 3, 1, 4, 6, 2, 5, 7]

In this case, the indices of upper, u, l, and losort are 8, which are 0 to 7. diag and lower are omitted. When non-zero elements are sorted by row-major, elements are a, b, c, d, e, f, g, and h, and when the non-zero elements are sorted by column-major, the elements are a, d, b, e, g, c, f, and h.

Since the first non-zero element at the row position 0 is a and the index of a in upper is 0, ownerStart[0] = 0 holds. Since the first non-zero element at the row position 1 is d and the index of d in upper is 3, ownerStart[1] = 3 holds. Since the first non-zero element at the row position 2 is g and the index of g in upper is 6, ownerStart[2] = 6 holds.

Since there is no non-zero element at the row position 3 to the row position 5, ownerStart[3] = ownerStart[4] = ownerStart[5] = 8. The element 8 indicates that the corresponding index does not exist in upper. ownerStart[6] represents the number of non-zero elements in all rows, and ownerStart[6] = 8 holds.

Since the indices of upper corresponding to a, d, b, e, g, c, f, and h of column-major are 0, 3, 1, 4, 6, 2, 5, and 7, respectively, losort = [0, 3, 1, 4, 6, 2, 5, 7].

In a case of the upper triangular matrix illustrated in FIG. 20, the CPU column coloring information of the CPU coloring information 2711 and the GPU column coloring information of the GPU coloring information 2812 are as follows.

nColors = 3, maxThreads = 2, sorted = [1, 2, 4, 3, 5], starts = [0, 1, 3, 5], threads = [1, 2, 2], kernels = [(0, false), (1, true), (3, N/A)]

In this example, a block size is 1. The indices of sorted are 5 of 0 to 4. An element 1 of the index 0 represents the column position 1 to which the color ID “0” is assigned. An element 2 of the index 1 and an element 4 of the index 2 represent the column position 2 and the column position 4 to which the color ID “1” is assigned. An element 3 of the index 3 and an element 5 of the index 4 represent the column position 3 and the column position 5 to which the color ID “2” is assigned.

Since the first column position to which the color ID “0” is assigned is 1 and the index of the column position 1 is 0, starts[0] = 0 holds. Since the first column position to which the color ID “1” is assigned is 2 and the index of the column position 2 is 1, starts[1] = 1 holds.

Since the first column position to which the color ID “2” is assigned is 3 and the index of the column position 3 is 3, starts[2] = 3 holds. Since the color ID “3” is not used, starts[3] = 5 holds. The element 5 represents that the corresponding index does not exist in sorted.

The CPU 2611 sets one or a plurality of columns to which the same color is assigned as a portion of an upper triangular matrix, and determines a synchronization method for a synchronization process between a first process using a non-zero element of a first portion and a second process using a non-zero element of a second portion. For the determination of the synchronization method, a number N1 of one or plurality of threads that process the non-zero elements of the first portion in the first process and a number N2 of one or a plurality of threads that process the non-zero elements of the second portion in the second process are used. The thread is an example of a processing unit.

The CPU 2611 determines the synchronization method as stream synchronization in a case where the number of one of N1 and N2 is equal to or smaller than a block size and the number of the other is larger than the block size. Therefore, stream synchronization is applied to a location at which the number of columns to which the same color is assigned is changed across the block size.

The CPU 2611 determines inter-block synchronization as the synchronization method in a case where both of N1 and N2 are larger than the block size, and determines intra-block synchronization as the synchronization method in a case where both of N1 and N2 are equal to or smaller than the block size.

In a case of the calculation process using the thread 0 and the thread 1 in FIG. 20, the calculation 2011 is regarded as the first process and the calculation 2012-1 and the calculation 2012-2 are regarded as the second process to determine a synchronization method of the synchronization process 2021. In this case, since N1 = 1 = block size and N2 = 2 > block size, stream synchronization is determined as the synchronization method in the synchronization process 2021.

Next, the synchronization method of the synchronization process 2022 is determined by regarding the calculation 2012-1 and the calculation 2012-2 as the first process and regarding the calculation 2013-1 and the calculation 2013-2 as the second process. In this case, since N1 = 2 > block size and N2 = 2 > block size, inter-block synchronization is determined as the synchronization method in the synchronization process 2022.

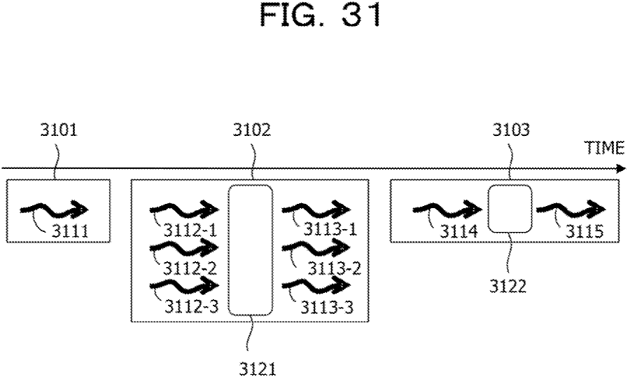

FIG. 29 illustrates an example of a synchronization process in a calculation process using the thread 0 and the thread 1 illustrated in FIG. 20. Since stream synchronization is determined as the synchronization method of the synchronization process 2021, a kernel 2901 and a kernel 2902 are activated in time series. The kernel 2901 includes a block 0, and the block 0 includes a thread 0. Since the block size is 1, the kernel 2902 includes the block 0 and the block 1, and each of the block 0 and the block 1 includes the thread 0.

The thread 0 in the block 0 of the kernel 2901 executes the calculation 2011. The thread 0 in the block 0 of the kernel 2902 executes the calculation 2012-1 and the calculation 2013-1 in time series. The thread 0 of the block 1 executes the calculation 2012-2 in parallel with the calculation 2012-1, and executes the calculation 2013-2 in parallel with the calculation 2013-1. After the calculation 2012-1 and the calculation 2012-2 are completed, inter-block synchronization 2911 is executed between the thread 0 of the block 0 and the thread 0 of the block 1.

kernels[0] = (0, false) represents the kernel 2901. A start offset 0 of the kernel 2901 represents an index of an element 1 of threads, and a flag false represents that the number of threads in the kernel 2901 is equal to or smaller than a block size.

kernels[1] = (1, true) represents the kernel 2902. A start offset 1 of the kernel 2902 represents an index of a first element 2 of threads, and a flag true represents that the number of threads in the kernel 2902 is larger than the block size.

kernels[2] = (3, N/A) is the last element of kernels, and a start offset 3 represents nColors.

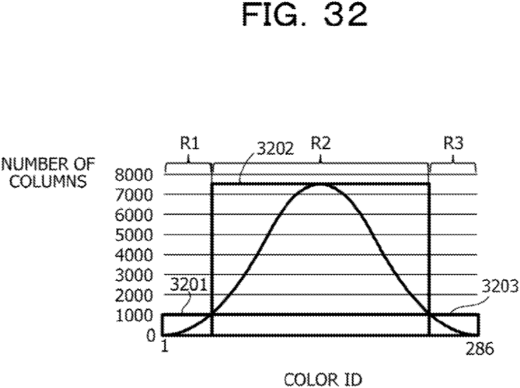

FIG. 30 illustrates an example of an upper triangular matrix having 10 rows and 10 columns. Row positions and column positions of the upper triangular matrix in FIG. 30 are represented by 0 to 9. Non-zero elements of the upper triangular matrix are a, b, c, d, e, f, g, h, i, j, k, l, and m.

In this example, the color ID “0” is assigned to the column position 1, the color ID “1” is assigned to the column positions 2, 7, and 8, and the color ID “2” is assigned to the column positions 3, 5, and 6. The color ID “3” is assigned to the column position 4, and the color ID “4” is assigned to the column position 9.

Therefore, a is colored with a color indicated by the color ID “0”, c, d, g, and h are colored with a color indicated by the color ID “1”, and b, e, f, i, j, and k are colored with a color indicated by the color ID “2”. l is colored with a color indicated by the color ID “3”, and m is colored with a color indicated by the color ID “4”.

In this case, the CPU column coloring information of the CPU coloring information 2711 and the GPU column coloring information of the GPU coloring information 2812 are as follows.

nColors = 5, maxThreads = 3, sorted = [1, 2, 7, 8, 3, 5, 6, 4, 9], starts = [0, 1, 4, 7, 8, 9], threads = [1, 3, 3, 1, 1], kernels = [(0, false), (1, true), (3, false), (5, N/A)]

In this example, a block size is 2. Indices of sorted are 9 of 0 to 8. An element 1 of the index 0 represents the column position 1 to which the color ID “0” is assigned. An element 2 of the index 1, an element 7 of the index 2, and an element 8 of the index 3 represent a column position 2, a column position 7, and a column position 8 to which the color ID “1” is assigned.

An element 3 of the index 4, an element 5 of the index 5, and an element 6 of the index 6 represent a column position 3, a column position 5, and a column position 6 to which the color ID “2” is assigned. An element 4 of the index 7 represents a column position 4 to which the color ID “3” is assigned. An element 9 of the index 8 represents a column position 9 to which the color ID “4” is assigned.

Since the first column position to which the color ID “0” is assigned is 1 and the index of the column position 1 is 0, starts[0] = 0 holds. Since the first column position to which the color ID “1” is assigned is 2 and the index of the column position 2 is 1, starts[1] = 1 holds. Since the first column position to which the color ID “2” is assigned is 3 and the index of the column position 3 is 4, starts[2] = 4 holds.

Since the first column position to which the color ID “3” is assigned is 4 and the index of the column position 4 is 7, starts[3] = 7 holds. Since the first column position to which the color ID “4” is assigned is 9 and the index of the column position 9 is 8, starts[4] = 8 holds. Since the color ID “5” is not used, starts[5] = 9 holds. The element 9 represents that the corresponding index does not exist in sorted.

FIG. 31 illustrates an example of a calculation process using the upper triangular matrix illustrated in FIG. 30. A calculation 3111 is a calculation using a at the column position 1, a calculation 3112-1 is a calculation using d at the column position 2, a calculation 3112-2 is a calculation using g at the column position 7, and a calculation 3112-3 is a calculation using c and h at the column position 8.

A calculation 3113-1 is a calculation using b, e, and I at the column position 3, a calculation 3113-2 is a calculation using f and j at the column position 5, and a calculation 3113-3 is calculation using k at the column position 6. A calculation 3114 is a calculation using l at the column position 4, and a calculation 3115 is a calculation using m at the column position 9.

Therefore, the calculation 3112-1 to the calculation 3112-3 are calculations using non-zero elements of the same color, and the calculation 3113-1 to the calculation 3113-3 are calculations using non-zero elements of the same color.

First, the calculation 3111 is regarded as a first process, the calculation 3112-1 to the calculation 3112-3 are regarded as a second process, and a synchronization method after the first process is completed is determined. In this case, since N1 = 1 < block size and N2 = 3 > block size, stream synchronization is determined as the synchronization method.

Next, the calculation 3112-1 to the calculation 3112-3 are regarded as the first process, the calculation 3113-1 to the calculation 3113-3 are regarded as the second process, and the synchronization method after the first process is completed is determined. In this case, since N1 = 3 > block size and N2 = 3 > block size, inter-block synchronization is determined as the synchronization method.

Next, the calculation 3113-1 to the calculation 3113-3 are regarded as the first process, the calculation 3114 is regarded as the second process, and the synchronization method after the first process is completed is determined. In this case, since N1 = 3 > block size and N2 = 1 < block size, stream synchronization is determined as the synchronization method.

Next, the calculation 3114 is regarded as the first process, the calculation 3115 is regarded as the second process, and the synchronization method after the first process is completed is determined. In this case, since N1 = 1 < block size and N2 = 1 < block size, intra-block synchronization is determined as the synchronization method.

Since the synchronization method after the calculation 3111 is completed and the synchronization method after the calculation 3113-1 to the calculation 3113-3 are completed are determined as stream synchronization, a kernel 3101 to a kernel 3103 are activated in time series.

The kernel 3101 executes the calculation 3111. After the calculation 3112-1 to the calculation 3112-3 are executed in parallel, the kernel 3102 executes inter-block synchronization 3121. Next, the kernel 3102 executes the calculation 3113-1 to the calculation 3113-3 in parallel. After the calculation 3114 is executed, the kernel 3103 executes intra-block synchronization 3122. Next, the kernel 3103 executes the calculation 3115.

kernels[0] = (0, false) represents the kernel 3101. A start offset 0 of the kernel 3101 represents an index of a first element 1 of threads, and a flag false represents that the number of threads in the kernel 3101 is equal to or smaller than a block size.

kernels[1] = (1, true) represents the kernel 3102. A start offset 1 of the kernel 3102 represents an index of a first element 3 of threads, and a flag true represents that the number of threads in the kernel 3102 is larger than the block size.

kernels[2] = (3, false) represents the kernel 3103. A start offset 3 of the kernel 3103 represents an index of a 2-th element 1 of threads, and a flag false represents that the number of threads in the kernel 3103 is equal to or smaller than the block size.

kernels[3] = (5, N/A) is the last element of kernels, and a start offset 5 represents nColors.

By enqueuing a kernel corresponding to each element of kernels in a stream, the CPU 2611 causes the GPU 2613 to execute a precondition. The arithmetic processing unit 2621 of the GPU 2613 executes the precondition by starting the enqueued kernel in time series. By completing the preceding kernel and starting the next kernel, the arithmetic processing unit 2621 executes a synchronization process of stream synchronization, and executes a synchronization process of inter-block synchronization or intra-block synchronization in accordance with the number of threads included in each kernel.

FIG. 32 illustrates an example of a synchronization method in the fluid analysis simulation illustrated in FIG. 21A. One kernel is activated for each of a range R1 to a range R3 of a color ID. Therefore, the number of kernels to be activated is 3. 1024 threads corresponding to a block size are used in the range R1 and the range R3, and threads more than 1024 are used in the range R2.

In the range R1, intra-block synchronization is executed after a calculation using a column of each color excluding the last color is completed, and stream synchronization is executed after a calculation using a column of the last color is completed. In the range R2, inter-block synchronization is executed after the calculation using the column of each color excluding the last color is completed, and stream synchronization is executed after the calculation using the column of the last color is completed. After the calculation using the column of each color excluding the last color is completed in the range R3, intra-block synchronization is executed.

An area of a rectangle 3201 represents a product of the number of colors and the number of threads in the range R1, an area of a rectangle 3202 represents a product of the number of colors and the number of threads in the range R2, and an area of a rectangle 3203 represents a product of the number of colors and the number of threads in the range R3. An area of each rectangle corresponds to the calculation amount of a calculation using the color column in the corresponding range.

With such a parallelization method, stream synchronization is applied only at a location at which the number of columns to which the same color is assigned is changed across a block size. Therefore, an activation cost of the kernel is reduced. In a case where the number of columns is larger than the block size, by applying inter-block synchronization with emphasis on a parallel count, speed-up by parallelization is promoted, and in a case where the number of columns is equal to or smaller than the block size, by applying intra-block synchronization with a low synchronization cost, the synchronization cost is reduced. As a result, the processing efficiency of the parallel process may be improved.

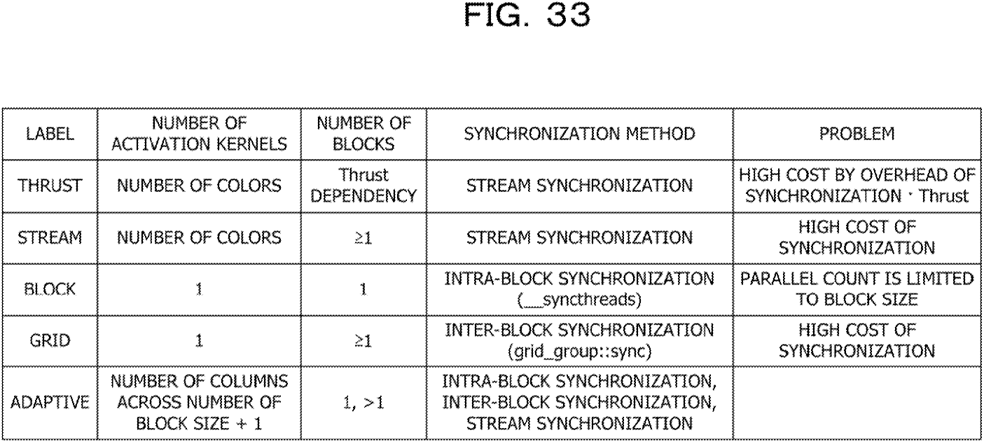

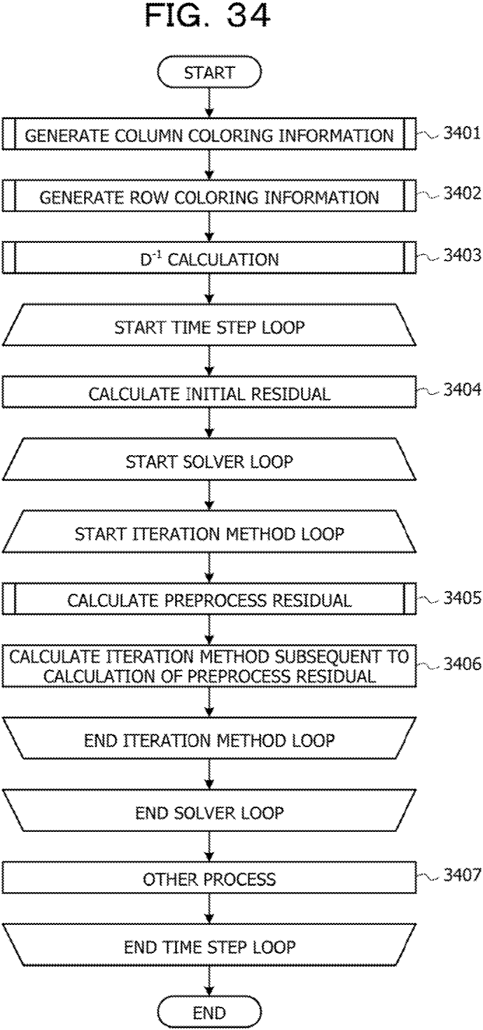

FIG. 33 illustrates an example of a comparison result of a parallelization method based on graph coloring. A label represents a name of the parallelization method, the number of activation kernels represents the number of kernels to be activated, and the number of blocks represents the number of blocks included in the kernel. A synchronization method represents a synchronization method after a calculation using a column of each color is completed, and a problem represents a problem of the parallelization method.

THRUST is a parallelization method using Thrust, which is a template library of compute unified device architecture (CUDA (registered trademark)), and a synchronization method of THRUST is stream synchronization. STREAM is a parallelization method using CUDA (registered trademark), and a synchronization method of STREAM is also stream synchronization.

A synchronization method of BLOCK is intra-block synchronization, and a synchronization method of GRID is inter-block synchronization. ADAPTIVE is a parallelization method of the embodiment, and as a synchronization method of ADAPTIVE, intra-block synchronization, inter-block synchronization, and stream synchronization are used in combination.

In a case of THRUST and STREAM, as many kernels as the number of colors are activated, so that overhead of the synchronization process increases the cost. In a case of THRUST, overhead of Thrust is further added. The parallel count is limited to the block size in a case of BLOCK, and a synchronization cost of inter-block synchronization is high in a case of GRID.

On the other hand, in a case of ADAPTIVE, the number of kernels becomes the number of columns across the block size + 1. Therefore, the activation cost of the kernel is reduced as compared with THRUST and STREAM. By adaptively selecting inter-block synchronization or intra-block synchronization in accordance with whether or not the number of columns exceeds the block size, the parallel count and the synchronization cost are optimized.

In a case where the lower triangular matrix is used, the synchronization method is also determined in the same manner as in a case where the upper triangular matrix is used. In a case where the synchronization method is determined by using row coloring information, in the CPU 2611, one or a plurality of rows to which the same color is applied is regarded as a portion of the upper triangular matrix or the lower triangular matrix, and the synchronization method is determined in the same manner as in a case where the column coloring information is used.

FIG. 34 is a flowchart illustrating an example of an analysis process performed by the information processing apparatus 2601 in FIG. 26. By executing an application program, the CPU 2611 performs the analysis process in FIG. 34. The analysis process corresponds to a fluid analysis simulation, a climate simulation, a molecular dynamics simulation, or the like.

First, the CPU 2611 acquires the sparse matrix information 2811 of each sparse matrix in an LDU format to be used in the analysis process from the GPU 2613. By using the sparse matrix information 2811, the CPU 2611 generates column coloring information for each of the upper triangular matrix U_{A} and the lower triangular matrix L_{A} of each sparse matrix (step 3401). The column coloring information includes nColors, maxThreads, threads, kernels, sorted, and starts.

Next, the CPU 2611 generates row coloring information for each of the upper triangular matrix U_{A} and the lower triangular matrix L_{A} of each sparse matrix (step 3402). The row coloring information includes nColors, maxThreads, threads, kernels, sorted, and starts.

Next, the CPU 2611 performs a calculation of D⁻¹ for each sparse matrix by using the GPU 2613 (step 3403). The CPU 2611 repeats a process in a time step loop in step 3404 to step 3407. The time step represents a processing step at a predetermined time interval to which an iteration method is applied in the analysis process.

In the process in the time step loop, the CPU 2611 instructs the GPU 2613 to calculate an initial residual (step 3404). The GPU 2613 calculates the initial residual. The initial residual represents b - Ax₀ in FIGS. 2 and 4, and b -A^{T}x₀ in FIG. 4. Next, the CPU 2611 repeats a solver loop process in step 3405 and step 3406.

The solver represents a numerical calculation for obtaining a solution of the simultaneous linear equation of Equation (2), and one or more solvers are used in accordance with a type of physical quantity or the like represented by x. For example, in a case of a fluid analysis simulation, a pressure solver that obtains a pressure at each lattice point and a velocity solver that obtains a speed at each lattice point may be used. The process of the solver loop is repeated for each solver.

In the process in the solver loop, the CPU 2611 repeats a process of an iteration method loop in step 3405 and step 3406. As the iteration method, a PCG method or a PBiCG method is used. In the process of the iteration method loop, the CPU 2611 uses the GPU 2613 to calculate a precondition residual (step 3405). In a case of the PCG method, the precondition residual in the DIC precondition is calculated, and in a case of the PBiCG method, the precondition residual in the DILU precondition is calculated.

Next, the CPU 2611 instructs the GPU 2613 to calculate an iteration method subsequent to the calculation of the precondition residual (step 3406). The GPU 2613 performs a calculation of the iteration method subsequent to the calculation of the precondition residual. A solution using the precondition residual, an update of the residual, and the like are included in the calculation of the iteration method subsequent to the calculation of the precondition residual. The process of the iteration method loop is repeated until the residual or the like satisfies an abort condition.

After the iteration of the solver loop process is completed, the CPU 2611 instructs the GPU 2613 to perform another process (step 3407). The GPU 2613 performs the other process, and the output unit 2614 outputs a processing result of the other process. Examples of the other process include a calculation using the solution obtained by the process of the solver loop and the like. The process of the time step loop is repeated until the last time step in the analysis process is reached.

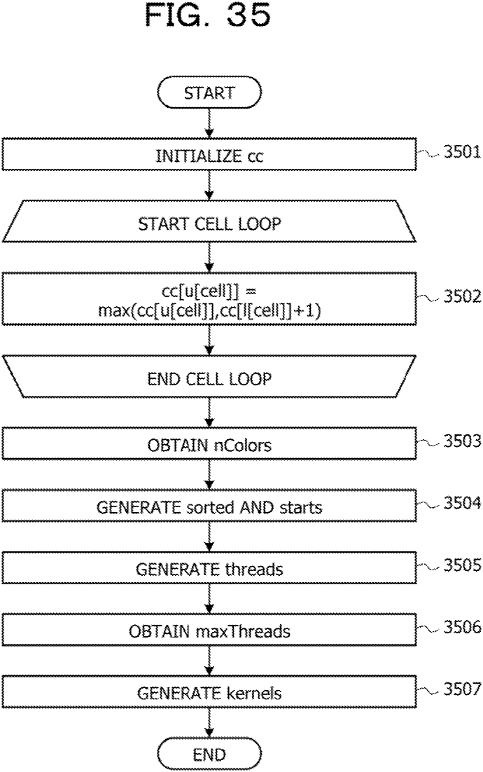

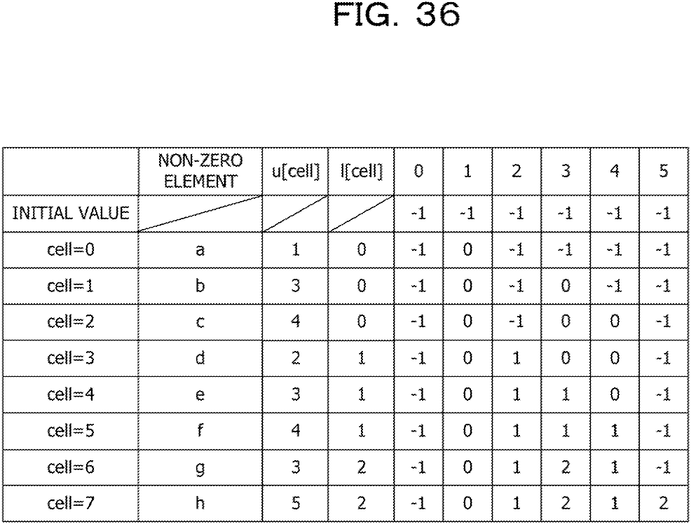

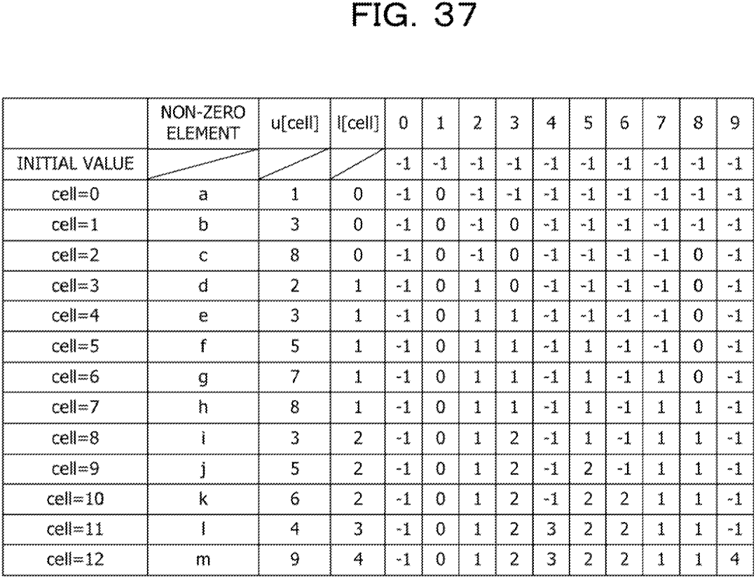

FIG. 35 is a flowchart illustrating an example of a column coloring information generation process in step 3401 in FIG. 34. In the column coloring information generation process in FIG. 35, each of the upper triangular matrix U_{A} and the lower triangular matrix L_{A} of each sparse matrix is used as a processing target matrix.

First, the CPU 2611 initializes an array cc representing a color ID of each column of the processing target matrix (step 3501). Therefore, each element of cc is set to an initial value of -1.

Next, the CPU 2611 repeats a process of a cell loop in step 3502. “cell” is a variable indicating a non-zero element included in the processing target matrix. In the process of the cell loop, the CPU 2611 updates cc[u[cell]] by the following equation (step 3502).

$$\text{cc} \left[\text{u} \left[\text{cell}\right]\right] = \text{max} \left(\text{cc} \left[\text{u} \left[\text{cell}\right]\right] , \text{cc} \left[\text{l} \left[\text{cell}\right]\right] + 1\right)$$

max(cc[u[cell]], cc[l[cell]] + 1) in Equation (41) represents the maximum value of cc[u[cell]] and cc[l[cell]] + 1.

Equation (41) represents that, in a case where there is an edge extending from a vertex l[cell] to a vertex u[cell] in a directed graph, a color ID next to a color ID of the vertex l[cell] is given to the vertex u[cell]. By repeating the process of the cell loop for each non-zero element, as illustrated in FIG. 12, a vertex having no end point of an edge and a vertex adjacent only to a reached vertex are colored one by one, and the color of each vertex is associated with each column.

FIG. 36 illustrates an example of a first color ID update process on the upper triangular matrix in FIG. 20. u[cell] represents a column position of a non-zero element indicated by cell, and l[cell] represents a row position of the non-zero element indicated by cell. 0 to 5 on the right side of l[cell] represents cc[0] to cc[5], and cc[j] (j = 0 to 5) represents a color ID of a column position j.

In this case, the cell is changed from 0 to 7, and cc[u[cell]] is updated in ascending order of cell. For example, when cell = 0, cc[u[0]] = cc[1] is calculated by the following equation.

$$\begin{matrix}\text{cc} \left[1\right] = \text{max} \left(\text{cc} \left[1\right] , \text{cc} \left[\text{l} \left[0\right]\right] + 1\right) \\ = \text{max} \left(- 1 , \text{cc} \left[0\right] + 1\right) \\ = \text{max} \left(- 1 , - 1 + 1\right) \\ = \text{max} \left(- 1 , \text{0}\right) \\ = 0\end{matrix}$$

Therefore, cc[1] is updated from -1 to 0 when cell = 0. In the same manner, cc[2] is updated from -1 to 1 when cell = 3. cc[3] is updated from -1 to 0 when cell = 1, updated from 0 to 1 when cell = 4, and updated from 1 to 2 when cell = 6. cc[4] is updated from -1 to 0 when cell = 2, and updated from 0 to 1 when cell = 5. cc[5] is updated from -1 to 0 when cell = 7.

Finally, the color ID “-1” is assigned to the column position 0, the color ID “0” is assigned to the column position 1, the color ID “1” is assigned to the column position 2 and the column position 4, and the color ID “2” is assigned to the column position 3 and the column position 5. Therefore, cc = [-1, 0, 1, 2, 1, 2] holds.

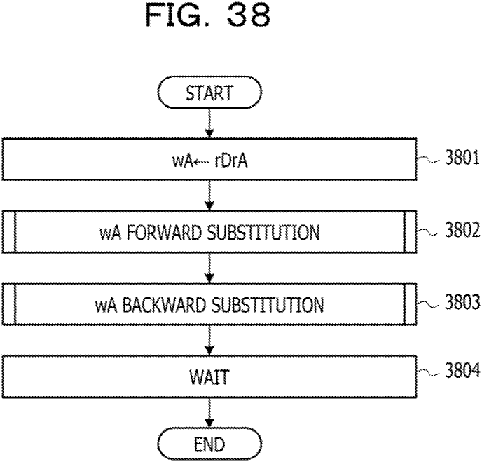

FIG. 37 illustrates an example of a second color ID update process for the upper triangular matrix in FIG. 30. 0 to 9 on the right side of l[cell] represents cc[0] to cc[9], and cc[j] (j = 0 to 9) represents a color ID of a column position j. In this case, the cell is changed from 0 to 12, and cc[u[cell]] is updated in ascending order of cell.

cc[1] is updated from -1 to 0 when cell = 0. cc[2] is updated from -1 to 1 when cell = 3. cc[3] is updated from -1 to 0 when cell = 1, updated from 0 to 1 when cell = 4, and updated from 1 to 2 when cell = 8. cc[4] is updated from -1 to 3 when cell = 11.

cc[5] is updated from -1 to 1 when cell = 5, and updated from 1 to 2 when cell = 9. cc[6] is updated from -1 to 2 when cell = 10. cc[7] is updated from -1 to 1 when cell = 6. cc[8] is updated from -1 to 0 when cell = 2, and updated from 0 to 1 when cell = 7. cc[9] is updated from -1 to 4 when cell = 12.

Finally, the color ID “-1” is assigned to the column position 0, the color ID “0” is assigned to the column position 1, the color ID “1” is assigned to the column position 2, the column position 7, and the column position 8, and the color ID “2” is assigned to the column position 3, the column position 5, and the column position 6. The color ID “3” is assigned to the column position 4, and the color ID “4” is assigned to the column position 9. Therefore, cc = [-1, 0, 1, 2, 3, 2, 2, 1, 1, 4] holds.

After the process of the cell loop is completed, the CPU 2611 obtains nColors by adding 1 to the maximum value of the element of cc (step 3503). Next, the CPU 2611 generates sorted by sorting column positions having color IDs of 0 or more in ascending order of the color IDs, and generates starts from sorted (step 3504).

Next, the CPU 2611 generates threads by acquiring the number of columns for each color ID (step 3505), and obtains the maximum value of the element of threads as maxThreads (step 3506).

Next, the CPU 2611 regards a column to which the same color ID is assigned as a portion of a processing target matrix, and determines a synchronization method of synchronization process between a first process using a non-zero element of a first portion and a second process using a non-zero element of a second portion. For the determination of the synchronization method, the number N1 of threads that process the non-zero element of the first portion in the first process and the number N2 of threads that process the non-zero element of the second portion in the second process are used.

The CPU 2611 determines the synchronization method as stream synchronization in a case where the number of one of N1 and N2 is equal to or smaller than a block size and the number of the other is larger than the block size. The CPU 2611 determines inter-block synchronization as the synchronization method in a case where both of N1 and N2 are larger than the block size, and determines intra-block synchronization as the synchronization method in a case where both of N1 and N2 are equal to or smaller than the block size.

Next, the CPU 2611 divides the elements of sorted at a location determined for stream synchronization, and allocates different kernels to one or a plurality of elements before the divided location and the one or the plurality of elements after the divided location, respectively. The CPU 2611 generates kernels having activation information of each kernel as an element (step 3507).

The CPU 2611 stores nColors, maxThreads, threads, and kernels in the storage unit 2612 as CPU column coloring information of the CPU coloring information 2711. The CPU 2611 transfers sorted, starts, and threads to the GPU 2613.

The arithmetic processing unit 2621 of the GPU 2613 stores sorted, starts, and threads received from the CPU 2611 in the storage unit 2622 as GPU column coloring information of the GPU coloring information 2812.

A row coloring information generation process in step 3402 in FIG. 34 also has the same manner as the column coloring information generation process in FIG. 35. In a case of the row coloring information generation process, an array cr representing a color ID of each row is used instead of the array cc representing the color ID of each column, and the following equation is used instead of Equation (41).

$$\text{cr} \left[\text{l} \left[\text{cell}\right]\right] = \text{max} \left(\text{cr} \left[\text{l} \left[\text{cell}\right]\right] , \text{cr} \left[\text{u} \left[\text{cell}\right]\right] + 1\right)$$

FIG. 38 is a flowchart illustrating an example of the process of calculating the precondition residual of the DIC precondition in step 3405 in FIG. 34, in a case where a PCG method is selected as the iteration method.

First, the CPU 2611 instructs the GPU 2613 to multiply rD[i] and rA[i] (step 3801). The GPU 2613 calculates a product of rD[i] and rA[i], and stores the product in wA[i].

Next, the CPU 2611 performs wA forward substitution by using the GPU 2613 (step 3802), and performs wA backward substitution by using the GPU 2613 (step 3803). wA forward substitution and wA backward substitution correspond to forward substitution and backward substitution in the DIC precondition, respectively. In wA forward substitution and wA backward substitution, the GPU 2613 executes a series of kernels included in a stream, and updates wA.

Next, the CPU 2611 waits until the execution of all the kernels included in the stream is completed (step 3804).

Even in the process of the next iteration method loop in a common GPU application, the update process on wA is enqueued in the same stream, and an order of calculation is often guaranteed. In this case, the waiting process in step 3804 may be omitted.

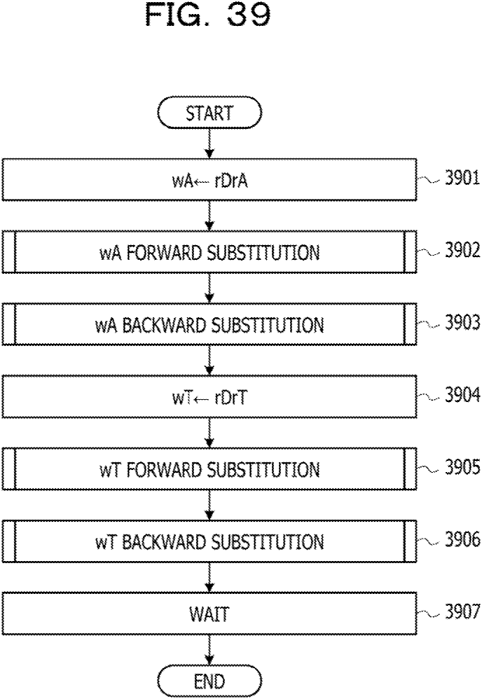

FIG. 39 is a flowchart illustrating an example of the process of calculating the precondition residual of the DILU precondition in step 3405 in FIG. 34, in a case where a PBiCG method is selected as the iteration method.

First, the CPU 2611 instructs the GPU 2613 to multiply rD[i] and rA[i] (step 3901). The GPU 2613 calculates a product of rD[i] and rA[i], and stores the product in wA[i].

Next, the CPU 2611 performs wA forward substitution by using the GPU 2613 (step 3902), and performs wA backward substitution by using the GPU 2613 (step 3903). wA forward substitution and wA backward substitution correspond to forward substitution and backward substitution in the DILU precondition, respectively. In wA forward substitution and wA backward substitution, the GPU 2613 executes a series of kernels included in a stream, and updates wA.

Next, the CPU 2611 instructs the GPU 2613 to multiply rD[i] and rT[i] (step 3904). The GPU 2613 calculates a product of rD[i] and rT[i], and stores the product in wT[i].

Next, the CPU 2611 performs wT forward substitution by using the GPU 2613 (step 3905), and performs wT backward substitution by using the GPU 2613 (step 3906). wT forward substitution and wT backward substitution correspond to forward substitution of a transposed version and backward substitution of a transposed version in the DILU precondition, respectively. In wT forward substitution and wT backward substitution, the GPU 2613 executes a series of kernels included in a stream, and updates wT.

Next, the CPU 2611 waits until the execution of all the kernels included in the stream is completed (step 3907).

At step 3403 in FIG. 34, step 3802 and step 3803 in FIG. 38, and step 3902, step 3903, step 3905, and step 3906 in FIG. 39, the kernel is enqueued in the stream by using the CPU coloring information 2711. Hereinafter, the process performed in these steps may be referred to as an enqueue process.

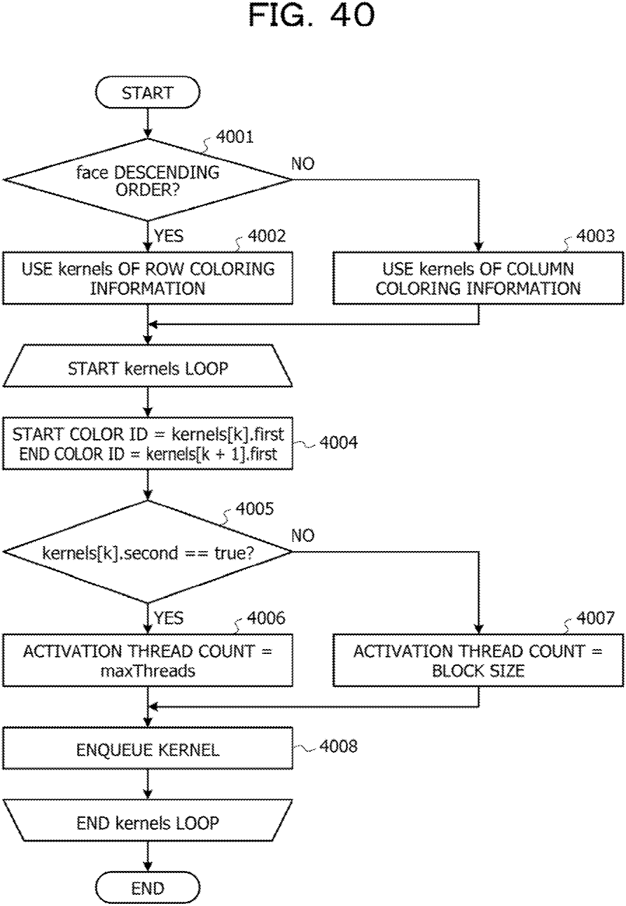

FIG. 40 is a flowchart illustrating an example of the enqueue process. First, the CPU 2611 checks whether or not face is changed in descending order, based on a precondition type, a kernel type, and a transposition type (step 4001).

The precondition type indicates whether a precondition is a DIC precondition or a DILU precondition, and the kernel type indicates whether the precondition is D⁻¹ calculation, forward substitution, or backward substitution. The transposition type indicates whether or not forward substitution and backward substitution in the DILU precondition are transposed versions.

Whether or not face is changed in descending order may be determined from the information in FIG. 18. In this case, face is changed in descending order in backward substitution in the DIC precondition, backward substitution in the DILU precondition, and backward substitution in the transposed version of the DILU precondition, and face is changed in ascending order in the other processes.

Therefore, face is changed in descending order in the enqueue processes in step 3803, step 3903, and step 3906, and face is changed in ascending order in the enqueue processes in step 3403, step 3802, step 3902, and step 3905.

In a case where face is changed in descending order (YES in step 4001), the CPU 2611 determines to use kernels of row coloring information (step 4002). On the other hand, in a case where face is changed in ascending order (NO in step 4001), the CPU 2611 determines to use kernels of column coloring information (step 4003).

Next, the CPU 2611 repeats a process of a kernels loop in step 4004 to step 4008. An index k of kernels is used in the process of the kernels loop. kernels[k].first represents a start offset included in an element of the index k of kernels. kernels[k].second represents a flag included in the element of the index k of kernels.

Since the last element of the kernels is not enqueued in a stream, when the number of elements of kernels is K, the process of the kernels loop is repeated for k = 0 to K — 2.

In the process of the kernels loop, the CPU 2611 determines a start color ID and an end color ID by the following equation (step 4004).

$$\text{start color ID} = \text{kernels} \left[\text{k}\right] . \text{first}$$

$$\text{end color ID} = \text{kernels} \left[\text{k} + 1\right] \text{.first}$$

Next, the CPU 2611 checks kernels[k].second (step 4005). In a case where kernels[k].second = true (YES in step 4005), the CPU 2611 determines an activation thread count as maxThreads (step 4006). On the other hand, in a case where kernels[k].second = false (NO in step 4005), the CPU 2611 determines the activation thread count as a block size (step 4007).

Next, the CPU 2611 enqueues a kernel corresponding to the element of the index k of kernels to the stream of the GPU 2613 (step 4008). As arguments of the kernel, a start color ID, an end color ID, an activation thread count, a precondition type, a kernel type, and a transposition type are used.

The arithmetic processing unit 2621 of the GPU 2613 activates the kernel enqueued in the stream in time series, and executes a process indicated by the precondition type, the kernel type, and the transposition type, by using the threads of the activation thread count. A plurality of blocks are used in a case where the activation thread count is larger than the block size, and a single block is used in a case where the activation thread count is the block size.

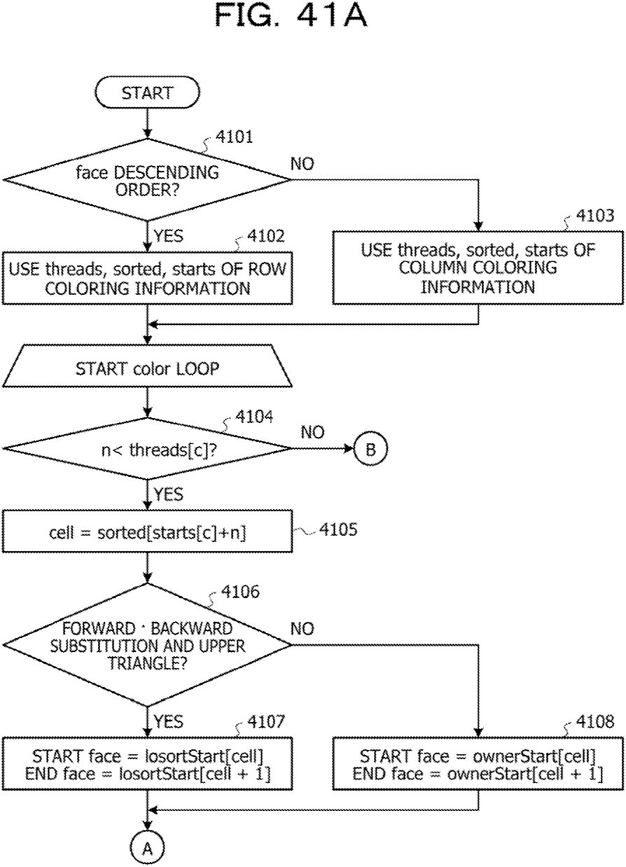

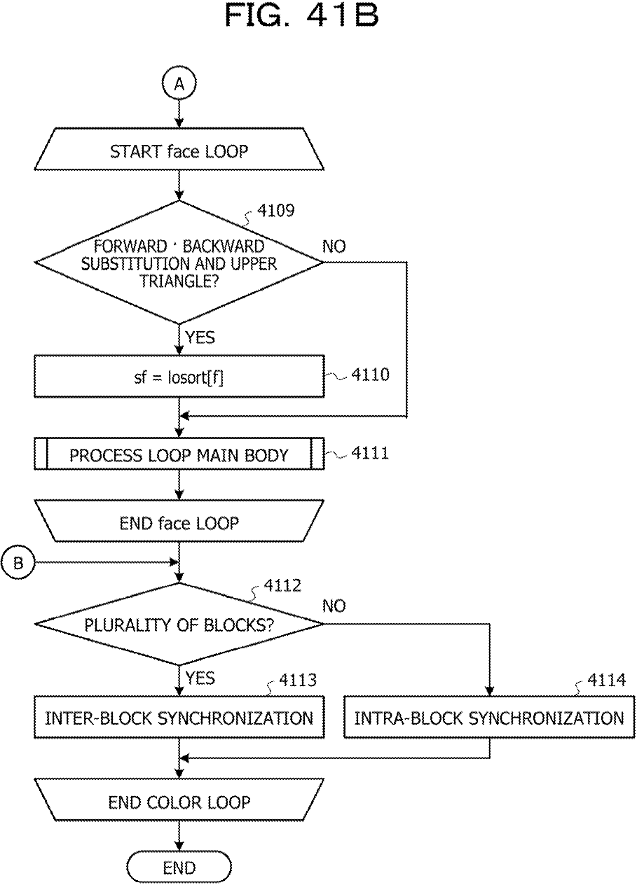

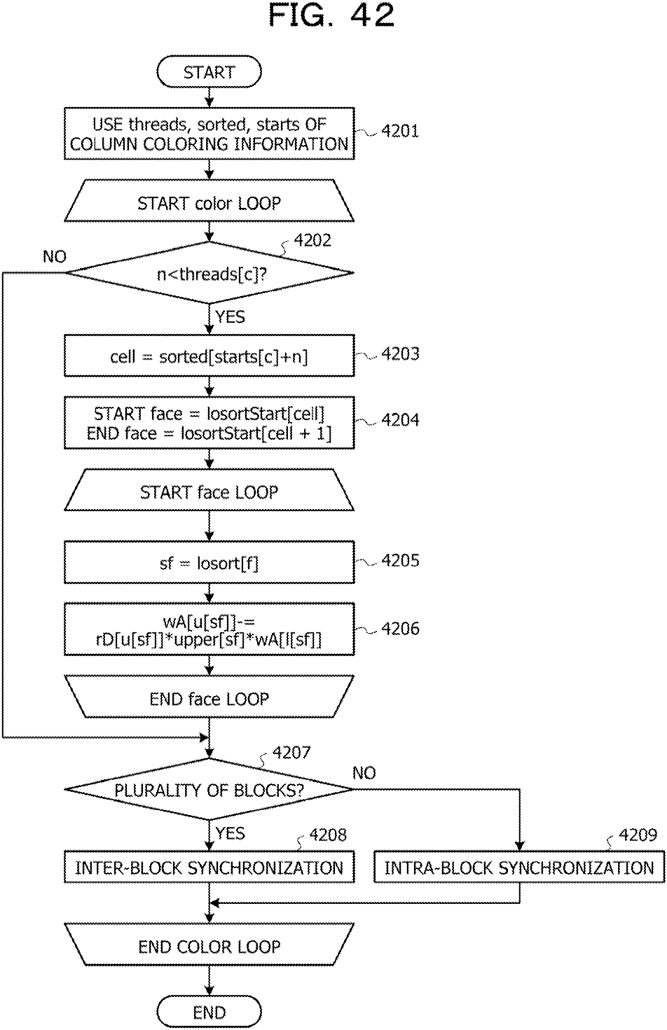

FIGS. 41A and 41B are a flowchart illustrating an example of a thread process performed by using an n-th thread (n = 0 to activation thread count - 1) among threads of the activation thread count. First, the arithmetic processing unit 2621 of the GPU 2613 checks whether or not face is changed in descending order, based on a precondition type, a kernel type, and a transposition type (step 4101).

In a case where face is changed in descending order (YES in step 4101), the arithmetic processing unit 2621 determines to use threads, sorted, and starts of row coloring information (step 4102). On the other hand, in a case where face is changed in ascending order (NO in step 4101), the arithmetic processing unit 2621 determines to use threads, sorted, and starts in column coloring information (step 4103).

Next, the arithmetic processing unit 2621 repeats a process of a color loop in step 4104 to step 4114. A variable c indicating a color ID is used in the process of the color loop. The process of the color loop is repeated for c = start color ID to end color ID - 1.

In the process of the color loop, the arithmetic processing unit 2621 compares n with threads[c] (step 4104). In a case where n is smaller than threads[c] (YES in step 4104), the arithmetic processing unit 2621 calculates cell by the following equation (step 4105).

$$\text{cell} = \text{sorted} \left[\text{starts} \left[\text{c}\right] + \text{n}\right]$$

Next, the arithmetic processing unit 2621 checks the kernel type and a matrix to be used (step 4106). The kernel type and the matrix to be used may be determined from the information in FIG. 18.

In a case where the kernel type is forward substitution or backward substitution and the matrix to be used is the upper triangular matrix U_{A} (YES in step 4106), the arithmetic processing unit 2621 determines start face and end face by the following equations (step 4107).

$$\text{start face} = \text{losortStart} \left[\text{cell}\right]$$

$$\text{end face} = \text{losortStart} \left[\text{cell} + 1\right]$$

On the other hand, in a case where the kernel type is a calculation of D⁻¹ or the matrix to be used is the lower triangular matrix L_{A} (NO in step 4106), the arithmetic processing unit 2621 determines start face and end face by the following equations (step 4108).

$$\text{start face} = \text{ownerStart} \left[\text{cell}\right]$$

$$\text{end face} = \text{ownerStart} \left[\text{cell} + 1\right]$$

Therefore, Equation (49) and Equation (50) are used in the enqueue process in step 3403, step 3902, and step 3906. Equation (47) and Equation (48) are used in the enqueue process in step 3802, step 3803, step 3903, and step 3905.

Next, the arithmetic processing unit 2621 repeats a process of a face loop in step 4109 to step 4111. A variable f indicating face is used in the process of the face loop. The process of the face loop is repeated for f = start face to end face -1. The face loop may be unrolled for speed-up.

In the process of the face loop, the arithmetic processing unit 2621 checks the kernel type and the matrix to be used (step 4109). In a case where the kernel type is forward substitution or backward substitution and the matrix to be used is the upper triangular matrix U_{A} (YES in step 4109), the arithmetic processing unit 2621 calculates sf by the following equation (step 4110).

$$\text{sf} = \text{losort} \left[\text{f}\right]$$

Next, the arithmetic processing unit 2621 performs the process of the loop main body illustrated in FIG. 18 (step 4111).

On the other hand, in a case where the kernel type is a calculation of D⁻¹ or the matrix to be used is the lower triangular matrix L_{A} (NO in step 4109), the arithmetic processing unit 2621 skips the process in step 4110 and performs the process of the loop main body (step 4111).

Therefore, the process in step 4110 is skipped in the enqueue processes of step 3403, step 3902, and step 3906, and the process in step 4110 is performed in the enqueue processes of step 3802, step 3803, step 3903, and step 3905.

Since parallelization for each column is a default in a kernel process in FIGS. 41A and 41B, losort in Equation (51) is applied in a case of forward substitution or backward substitution using the upper triangular matrix U_{A}. losortStart in Equation (47) and Equation (48) is used instead of ownerStart in Equation (49) and Equation (50).

On the other hand, in a case of the calculation of D⁻¹, forward substitution using the lower triangular matrix L_{A}, or backward substitution using the lower triangular matrix L_{A}, losort in Equation (51) is not applied, and ownerStart in Equation (49) and Equation (50) is used.

Therefore, in a case where the kernel type is forward substitution or backward substitution, in step 4111, the arithmetic processing unit 2621 calculates wA or wT by using a calculation equation in which f and sf included in the loop main body before parallelization illustrated in FIG. 18 are replaced with each other.

On the other hand, in a case where the kernel type is the calculation of D⁻¹, the arithmetic processing unit 2621 calculates rD by using the loop main body before parallelization illustrated in FIG. 18, in step 4111. At step 3403, the enqueue process in FIG. 40 is executed for each solver. The loop main body of the calculation of D⁻¹ in the DIC precondition is used in a case of the solver using the PCG method, and the loop main body of the calculation of D⁻¹ in the DILU precondition is used in a case of the solver using the PBiCG method.

Next, the arithmetic processing unit 2621 checks the number of blocks included in a kernel being executed (step 4112). In a case where the kernel includes a plurality of blocks (YES in step 4112), the arithmetic processing unit 2621 executes a synchronization process by applying inter-block synchronization (step 4113). On the other hand, in a case where only a single block is included in the kernel (NO in step 4112), the arithmetic processing unit 2621 executes the synchronization process by applying intra-block synchronization (step 4114).

Meanwhile, in a case where c = end color ID - 1, the process in step 4112 to step 4114 is omitted. In a case where n is equal to or greater than threads[c] (NO in step 4104), the arithmetic processing unit 2621 performs the process in step 4112 and subsequent steps.

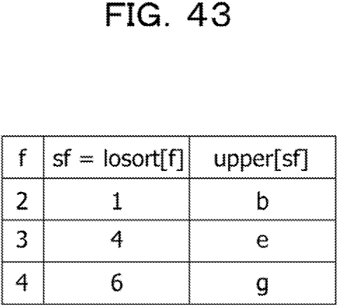

FIG. 42 is a flowchart illustrating an example of a DIC forward substitution thread process in a case where a precondition type is a DIC precondition and a kernel type is forward substitution, in the thread process in FIGS. 41A and 41B.

In this case, since face is changed in ascending order, the arithmetic processing unit 2621 determines to use threads, sorted, and starts in column coloring information (step 4201).

Next, the arithmetic processing unit 2621 repeats a process in a color loop in step 4202 to step 4209. The process of the color loop is repeated for c = start color ID to end color ID - 1.

The process in step 4202 and step 4203 has the same manner as the process in step 4104 and step 4105 in FIGS. 41A and 41B. In this case, since the kernel type is forward substitution and a matrix to be used is the upper triangular matrix U_{A}, the arithmetic processing unit 2621 determines start face and end face, by Equation (47) and Equation (48) (step 4204).

Next, the arithmetic processing unit 2621 repeats a process of a face loop in step 4205 and step 4206. The process of the face loop is repeated in ascending order of face, for f = start face to end face - 1.

The process in step 4205 has the same manner as the process in step 4110 in FIGS. 41A and 41B. In this case, since the precondition type is a DIC precondition and the kernel type is forward substitution, the arithmetic processing unit 2621 calculates wA by the following equation (step 4206).

$$\text{wA} \left[\text{u} \left[\text{sf}\right]\right] - = \text{rD} \left[\text{u} \left[\text{sf}\right]\right] * \text{upper} \left[\text{sf}\right] * \text{wA} \left[\text{l} \left[\text{sf}\right]\right]$$

Equation (52) represents a calculation equation in which f included in the loop main body of forward substitution in the DIC precondition illustrated in FIG. 18 is replaced with sf. The process in step 4207 to step 4209 has the same manner as the process in step 4112 to step 4114 in FIGS. 41A and 41B.

FIG. 43 illustrates an example of sf for the upper triangular matrix illustrated in FIG. 20. The sparse matrix information 2811 of the upper triangular matrix in FIG. 20 is as follows.

upper = [a, b, c, d, e, f, g, h], u = [1, 3, 4, 2, 3, 4, 3, 5], l = [0, 0, 0, 1, 1, 1, 2, 2], losortStart = [0, 0, 1, 2, 5, 7, 8], losort = [0, 3, 1, 4, 6, 2, 5, 7]

sorted and starts are as follows.

sorted = [1, 2, 4, 3, 5], starts = [0, 1, 3, 5]

In a case of n=0 and c = 2, cell = 3 holds, by Equation (46). Therefore, from Equation (47) and Equation (48), start face = 2 and end face = 5 holds.

In this case, the process of the face loop is repeated for f = 2 to 4. According to Equation (51), sf = 1 when f = 2, sf = 4 when f = 3, and sf = 6 when f = 4. Since upper[1] = b, upper[4] = e, and upper[6] = g holds, the process in step 4206 in FIG. 42 is performed for b, e, and g that are the non-zero elements at the column position 3.

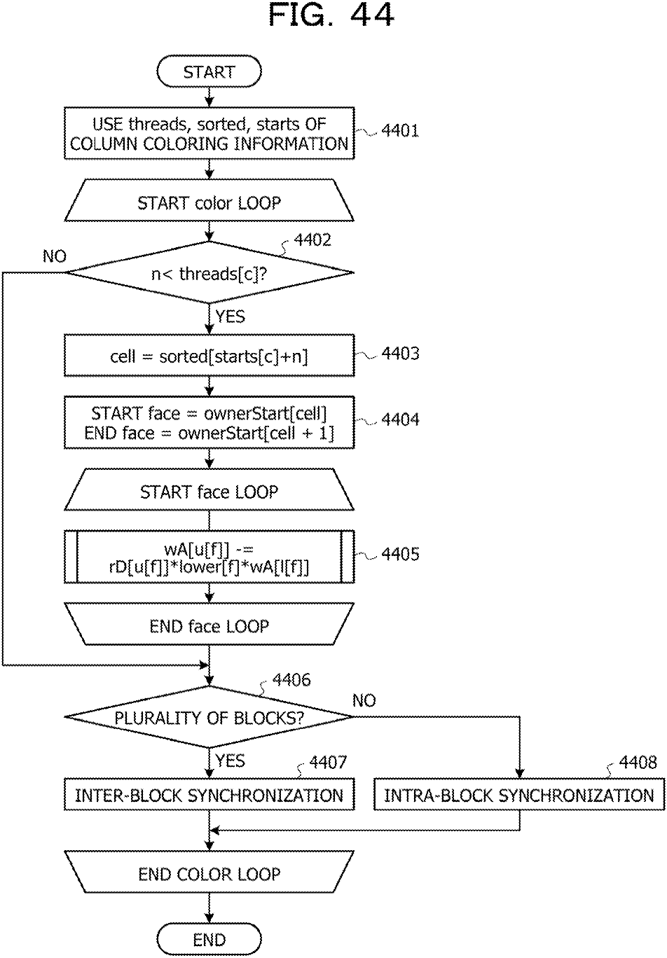

FIG. 44 is a flowchart illustrating an example of a DILU forward substitution thread process in a case where a precondition type is a DILU precondition and a kernel type is forward substitution in the thread process in FIGS. 41A and 41B.

In this case, since face is changed in ascending order, the arithmetic processing unit 2621 determines to use threads, sorted, and starts in column coloring information (step 4401).

Next, the arithmetic processing unit 2621 repeats a process of a color loop in step 4402 to step 4408. The process of the color loop is repeated for c = start color ID to end color ID - 1.

The process in step 4402 and step 4403 has the same manner as the process in step 4104 and step 4105 in FIGS. 41A and 41B. In this case, since the kernel type is forward substitution and the matrix to be used is the lower triangular matrix L_{A}, the arithmetic processing unit 2621 determines start face and end face, by Equation (49) and Equation (50) (step 4404).

Next, the arithmetic processing unit 2621 repeats a process of a face loop in step 4405. The process of the face loop is repeated in ascending order of face, for f = start face to end face - 1.

In this case, since the precondition type is a DILU precondition and the kernel type is forward substitution, the arithmetic processing unit 2621 calculates wA by the following equation (step 4405).

$$\text{wA} \left[\text{u} \left[\text{f}\right]\right] - = \text{rD} \left[\text{u} \left[\text{f}\right]\right] * \text{lower} \left[\text{f}\right] * \text{wA} \left[\text{l} \left[\text{f}\right]\right]$$

Equation (53) represents a calculation equation in which sf included in the loop main body of forward substitution in the DILU precondition illustrated in FIG. 18 is replaced with f. The process in step 4406 to step 4408 has the same manner as the process in step 4112 to step 4114 in FIGS. 41A and 41B.

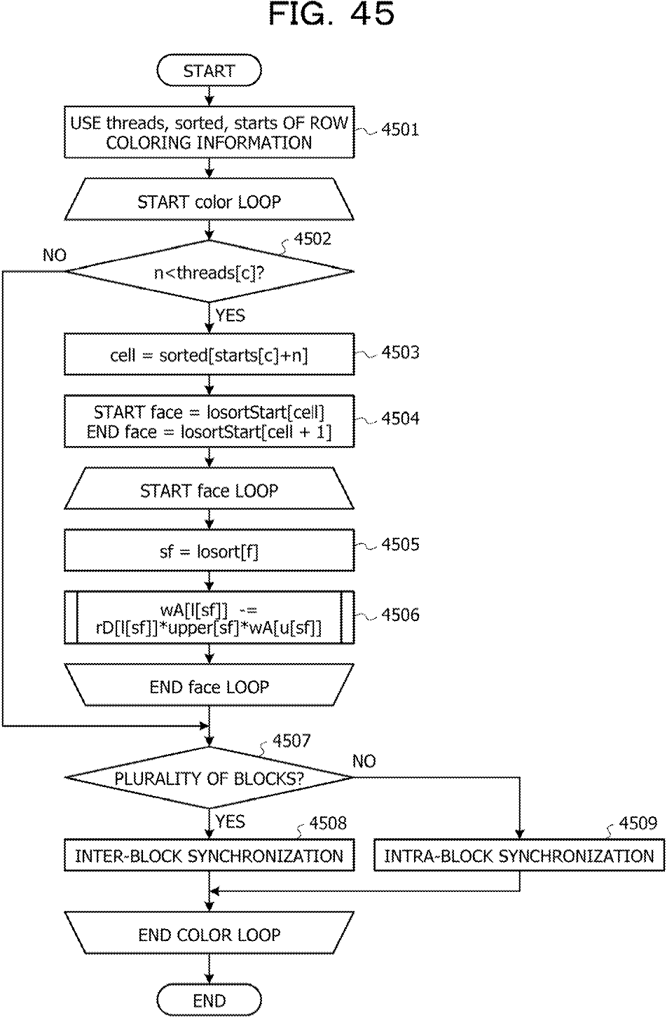

FIG. 45 is a flowchart illustrating an example of a DILU backward substitution thread process in a case where a precondition type is a DILU precondition and a kernel type is backward substitution, in the thread process in FIGS. 41A and 41B.

In this case, since face is changed in descending order, the arithmetic processing unit 2621 determines to use threads, sorted, and starts in row coloring information (step 4501).

Next, the arithmetic processing unit 2621 repeats a process of a color loop in step 4502 to step 4509. The process of the color loop is repeated for c = start color ID to end color ID - 1.

The process in step 4502 and step 4503 has the same manner as the process in step 4104 and step 4105 in FIGS. 41A and 41B. In this case, since the kernel type is backward substitution and the matrix to be used is the upper triangular matrix U_{A}, the arithmetic processing unit 2621 determines start face and end face by Equation (47) and Equation (48) (step 4504).

Next, the arithmetic processing unit 2621 repeats a process of a face loop in step 4505 and step 4506. The process of the face loop is repeated in descending order of face, for f = end face - 1 to start face.

The process in step 4505 has the same manner as the process in step 4110 in FIGS. 41A and 41B. In this case, since the precondition type is a DILU precondition and the kernel type is backward substitution, the arithmetic processing unit 2621 calculates wA by the following equation (step 4506).

$$\text{wA} \left[\text{I} \left[\text{sf}\right]\right] - = \text{rD} \left[\text{I} \left[\text{sf}\right]\right] * \text{upper} \left[\text{sf}\right] * \text{wA} \left[\text{u} \left[\text{sf}\right]\right]$$

Equation (54) represents a calculation equation in which f included in the loop main body of backward substitution in the DILU precondition illustrated in FIG. 18 is replaced with sf. The process in step 4507 to step 4509 has the same manner as the process in step 4112 to step 4114 in FIGS. 41A and 41B.

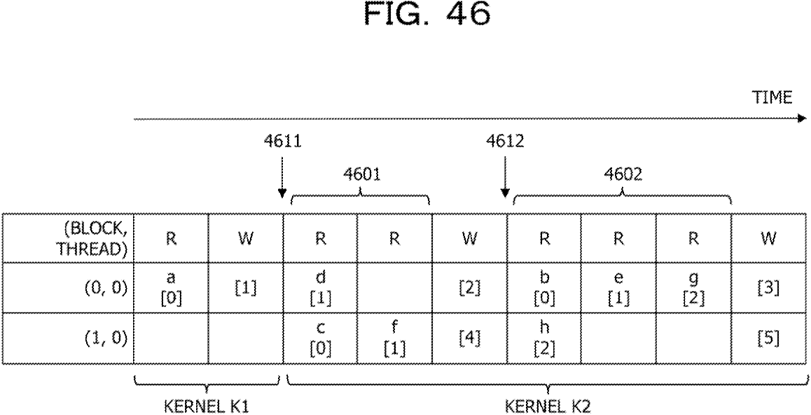

FIG. 46 illustrates an example of a timeline of a first DIC forward substitution thread process using the upper triangular matrix in FIG. 20. In this example, a block size is 1.

(block, thread) represents a combination of a block ID and a thread ID. (0, 0) represents a thread 0 included in a block 0 of each kernel, and (1, 0) represents a thread 0 included in a block 1 of each kernel. The thread 0 included in the block 0 corresponds to a 0-th thread, among threads of an activation thread count. The thread 0 included in the block 1 corresponds to a 1-th thread among threads of the activation thread count.

R represents a read access to upper and wA, and W represents a write access to wA. a to h represent non-zero elements stored in upper, and [s] (s = 0 to 5) represents wA[s].

A kernel K1 corresponds to kernels[0], and includes a single block. A kernel K2 corresponds to kernels[1], and includes 2 blocks. The read access to upper and wA in periods 4601 and 4602 is executed by expanding a face loop.

At a timing 4611, stream synchronization is executed, and at a timing 4612, inter-block synchronization is executed.

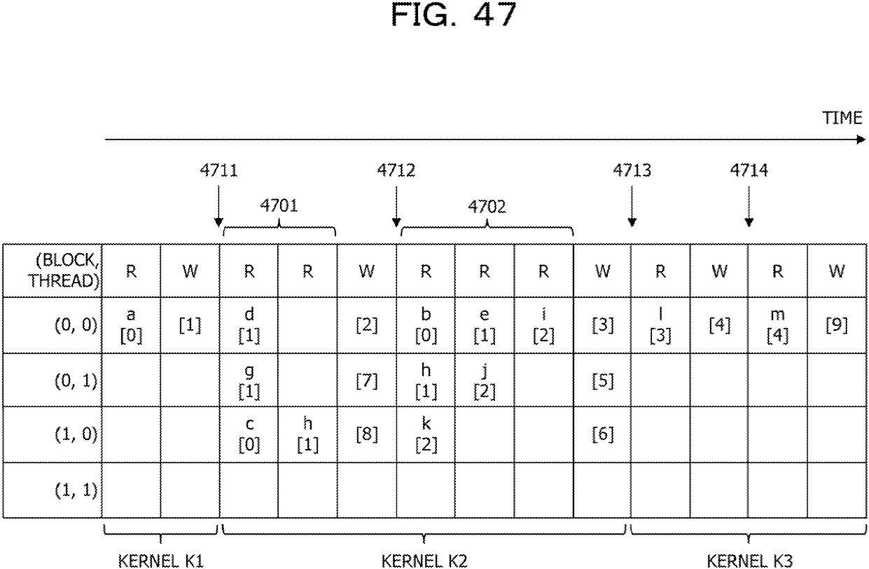

FIG. 47 illustrates an example of a timeline of a second DIC forward substitution thread process using the upper triangular matrix in FIG. 30. In this example, a block size is 2.

(0, 0) represents a thread 0 included in a block 0 of each kernel, and (0, 1) represents a thread 1 included in the block 0 of each kernel. (1, 0) represents a thread 0 included in a block 1 of each kernel, and (1, 1) represents a thread 1 included in the block 1 of each kernel.

The thread 0 included in the block 0 corresponds to a 0-th thread, among threads of an activation thread count. The thread 1 included in the block 0 corresponds to a 1-th thread, among the threads of the activation thread count. The thread 0 included in the block 1 corresponds to a 3-th thread, among the threads of the activation thread count.

a to m represent non-zero elements stored in upper, and [s] (s = 0 to 9) represents wA[s].

The kernel K1 corresponds to kernels[0], and includes a single block. The kernel K2 corresponds to kernels[1], and includes 2 blocks. A kernel K3 corresponds to kernels[2], and includes a single block. The read access to upper and wA in periods 4701 and 4702 is executed by expanding a face loop.

At a timing 4711 and a timing 4713, stream synchronization is executed, at a timing 4712, inter-block synchronization is executed, and at a timing 4714, intra-block synchronization is executed.

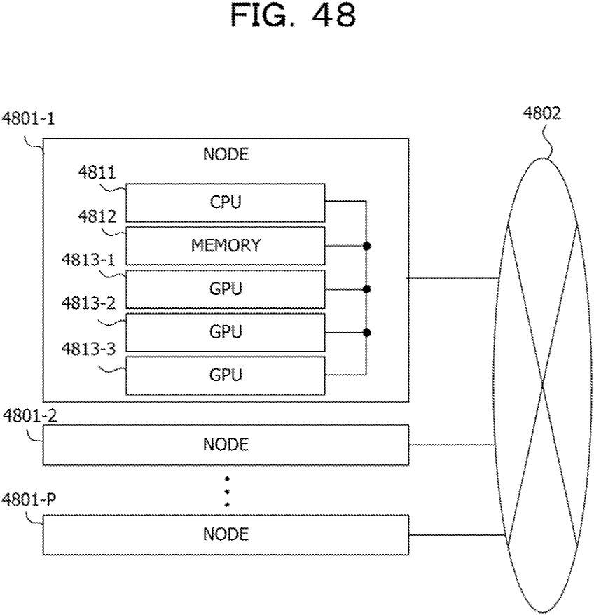

FIG. 48 illustrates a hardware configuration example of an information processing apparatus including a plurality of nodes. The information processing apparatus illustrated in FIG. 48 includes a node 4801-1 to a node 4801-P (P is an integer equal to or greater than 2). Each node 4801-p (p = 1 to P) includes a CPU 4811, a memory 4812, and a GPU 4813-1 to a GPU 4813-3.

Each GPU 4813-q (q = 1 to 3) includes an arithmetic processing unit and a storage unit, in the same manner as the GPU 2613 in FIG. 26. The arithmetic processing units in the CPU 4811 and the GPU 4813-q correspond to the determination unit 2411 and the arithmetic processing unit 2412 in FIG. 24, respectively. The memory 4812 stores the same information as the information in FIG. 27, and the storage unit in the GPU 4813-q stores the same information as the information in FIG. 28.

The node 4801-1 to the node 4801-P may communicate with each other via a communication network 4802. Each node 4801-p may include the 4 or more nodes GPU 4813-q.

The information processing apparatus illustrated in FIG. 48 may perform an analysis process by dividing a sparse matrix in an LDU format. In this case, the 3 GPUs 4813-q divide the sparse matrix, and executes a thread process of a calculation of D⁻¹, forward substitution, or backward substitution in a DIC precondition or a DILU precondition. For each GPU 4813-q, the CPU 4811 activates the process, and performs the analysis process.

Each GPU 4813-q does not communicate with the other GPU 4813-q during the execution of the thread process. In a case where boundary communication of SpMV, global inner product calculation, or the like occurs, communication is performed with the node 4813-q or with the node 4801-p.

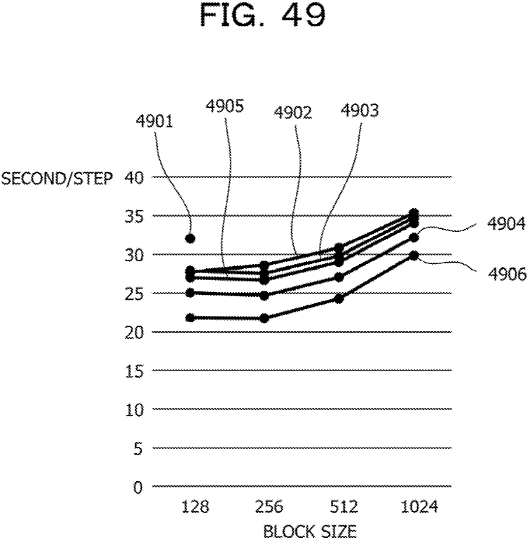

FIG. 49 illustrates an example of performance in a fluid analysis simulation for calculating a pressure and a velocity of a 200×200×200 cubic lattice. In this example, a 3-D Lid Driven cavity flow of OpenFOAM HPC Benchmark suite is used, a PCG method is used to calculate the pressures, and a PBiCG method is used to calculate the velocity.

A horizontal axis represents a block size, and a vertical axis represents a processing time (sec) per one time step. A point 4901 represents performance of THRUST illustrated in FIG. 33. In a case of THRUST, since the block size is unknown, the point 4901 is plotted at a position of block size = 128.

A polygonal line 4902 represents performance of STREAM, a polygonal line 4903 represents performance of GRID, and a polygonal line 4904 represents performance of GRID (unroll = 3). A polygonal line 4905 represents performance of ADAPTIVE, and a polygonal line 4906 represents performance of ADAPTIVE (unroll = 3).

unroll = 3 indicates that first 3 iterations included in a face loop are unrolled and executed. Since the coefficient matrix A is a seven fold diagonal matrix in a three-dimensional cubic lattice, unroll = 3 is optimal.

It may be seen that a processing speed of ADAPTIVE (unroll = 3) indicated by the polygonal line 4906 is approximately 1.5 times faster than a processing speed of THRUST indicated by the point 4901, and approximately 1.1 times faster than a processing speed of GRID (unroll = 3) indicated by the polygonal line 4904.

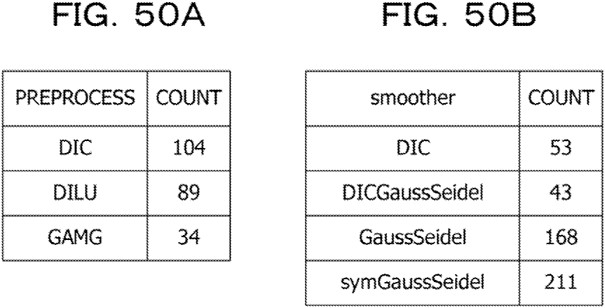

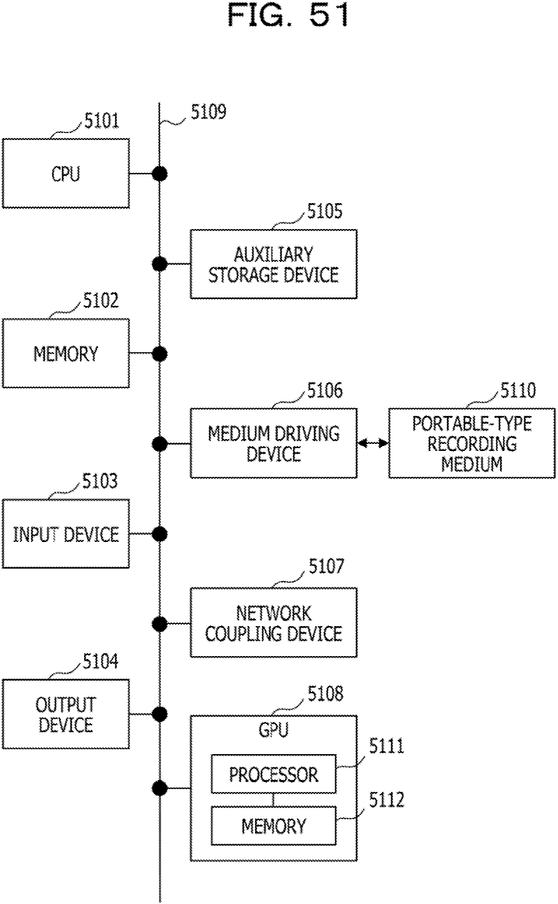

FIGS. 50A and 50B illustrate an example of the numbers of preconditions and smoothers used in an OpenFOAM v8 tutorial. FIG. 50A illustrates an example of the number of preconditions. DIC represents a DIC precondition, DILU represents a DILU precondition, and generalised geometric-algebraic multi-grid (GAMG) represents a GAMG precondition.

FIG. 50B illustrates an example of the number of smoothers. DIC represents a DIC smoother, DICGaussSeidel represents DIC Gaussian = Seidel smoother, GaussSeidel represents Gaussian = Seidel smoother, and symGaussSeidel represents symmetric Gaussian = Seidel smoother.

The DIC precondition and the DILU precondition are frequently used in fields such as fluid analysis. Therefore, high-speed GPU implementation for the DIC precondition and the DILU precondition makes a large contribution to software solutions in these fields.

The configurations of the information processing apparatus 2401 in FIG. 24, the information processing apparatus 2601 in FIG. 26, and the information processing apparatus in FIG. 48 are merely examples, and some of components may be omitted or modified in accordance with an application or a condition of the information processing apparatus. For example, the parallel process may be executed by using another arithmetic processing apparatus such as a CPU instead of the GPU. In this case, another processing unit such as a process may be used instead of the thread.

The information illustrated in FIG. 27 and FIG. 28 is merely an example, and a part of the information may be omitted or changed in accordance with an application or a condition of the information processing apparatus.

The flowcharts in FIG. 25, FIG. 34, FIG. 35, FIGS. 38 to 42, FIG. 44, and FIG. 45 are merely examples, and some of the processes may be omitted or modified in accordance with the configuration or the condition of the information processing apparatus.

The coefficient matrices illustrated in FIGS. 1A, 1B, and FIG. 3 are merely examples, and changed in accordance with the matrix process included in the analysis process. The lower triangular matrices illustrated in FIG. 6 and FIG. 9 are merely examples, and changed in accordance with the coefficient matrix used in the analysis process. The upper triangular matrices illustrated in FIG. 7, FIG. 9, FIG. 11, FIG. 12, FIG. 15, FIG. 20, and FIG. 30 are merely examples, and changed in accordance with the coefficient matrix used in the analysis process.

An algorithm of the PCG method illustrated in FIG. 2 and an algorithm of the PBiCG method illustrated in FIG. 4 are merely examples, and the PCG method and the PBiCG method may be described in different formats. The programs of the DILU precondition illustrated in FIG. 5A and FIG. 5B are merely examples, and the program of the DILU precondition may be described in another format.

The DILU precondition illustrated in FIG. 8, and the DIC precondition and the DILU precondition illustrated in FIG. 10 and FIG. 18 are merely examples, and the DIC precondition and the DILU precondition may be described in different formats. The parallelization illustrated in FIG. 13, FIG. 14, FIG. 16, FIG. 17, and FIG. 19 is merely an example, and a result of the parallelization is changed in accordance with the upper triangular matrix or the lower triangular matrix to be used.

The simulation results illustrated in FIGS. 21A and 21B, FIG. 32, and FIG. 49 are merely examples, and the simulation results are changed in accordance with the coefficient matrix used in the simulation. The synchronization methods illustrated in FIGS. 22A to 22C, FIGS. 23A to 23C, FIG. 29, FIG. 31, and FIG. 33 are merely examples, and another synchronization method for the threads may be used.

The color ID update processes illustrated in FIGS. 36 and 37 are merely examples, and the color ID update processes are changed in accordance with the coefficient matrix used in the analysis process. The index illustrated in FIG. 43 is merely an example, and the index of the non-zero element is changed in accordance with the coefficient matrix used in the analysis process. The timelines illustrated in FIG. 46 and FIG. 47 are merely examples, and the timeline of the DIC forward substitution thread process is changed in accordance with the coefficient matrix used in the analysis process.

The precondition and the smoother illustrated in FIGS. 50A and 50B is merely an example, and the DIC precondition and the DILU precondition are used in various applications.

Equation (1) to Equation (54) are merely examples, and the matrix process may be described by using another calculation equation.

FIG. 51 illustrates an example of a hardware configuration of the information processing apparatus 2401 illustrated in FIG. 24 and the information processing apparatus 2601 illustrated in FIG. 26. An information processing apparatus illustrated in FIG. 51 includes a CPU 5101, a memory 5102, an input device 5103, an output device 5104, an auxiliary storage device 5105, a medium driving device 5106, a network coupling device 5107, and a GPU 5108. These components are hardware, and coupled each other via a bus 5109.

The memory 5102 is, for example, a semiconductor memory such as a read-only memory (ROM) or a random-access memory (RAM), and stores a program and data used for processing. The memory 5102 may operate as the storage unit 2612 illustrated in FIG. 26.

For example, the CPU 5101 executes the program by using the memory 5102 to operate as the determination unit 2411 in FIG. 24. The CPU 5101 also operates as the CPU 2611 in FIG. 26. The CPU 5101 is also referred to as a processor in some cases.

The input device 5103 is, for example, a keyboard, a pointing device, or the like, and is used to input an instruction or information from a user or operator. The output device 5104 is, for example, a display device, a printer or the like, and is used to output an inquiry or instruction to the user or operator, and processing results. The processing result may be a result of calculation using a solution for each time step. The output device 5104 may also operate as the output unit 2614 in FIG. 26.

For example, the auxiliary storage device 5105 is a magnetic disk device, an optical disc device, a magneto-optical disc device, and a tape device, or the like. The auxiliary storage device 5105 may be a hard disk drive or a solid-state drive (SSD). The information processing apparatus may store a program and data in the auxiliary storage device 5105, and load those program and data into the memory 5102 for use. The auxiliary storage device 5105 may operate as the storage unit 2612 in FIG. 26.

The medium driving device 5106 drives a portable-type recording medium 5110, and accesses recorded contents. The portable-type recording medium 5110 is a memory device, a flexible disk, an optical disc, a magneto-optical disc, or the like. The portable-type recording medium 5110 may be a compact disk read-only memory (CD-ROM), a Digital Versatile Disk (DVD), a Universal Serial Bus (USB), or the like. The user or operator may store a program and data in the portable-type recording medium 5110, and load those program and data into the memory 5102 for use.

In this manner, the computer readable recording medium storing the program and data used for processing is a physical (non-transitory) recording medium, such as the memory 5102, the auxiliary storage device 5105, or the portable-type recording medium 5110.

The network coupling device 5107 is a communication interface circuit coupled to a communication network such as a local area network (LAN) or a wide area network (WAN) to perform data conversion associated with communication. The information processing apparatus may receive the program and data from an external apparatus via the network coupling device 5107 and load those program and data into the memory 5102 for use. The network coupling device 5107 may operate as the output unit 2614 in FIG. 26.

The GPU 5108 includes a processor 5111 and a memory 5112, performs a process instructed by the CPU 5101, and outputs a processing result to the CPU 5101. The GPU 5108 may operate as the GPU 2613 in FIG. 26. The processor 5111 may operate as the arithmetic processing unit 2412 in FIG. 24 or the arithmetic processing unit 2621 in FIG. 26, and the memory 5112 may operate as the storage unit 2622 in FIG. 26.

The information processing apparatus does not necessarily include all the components in FIG. 51, and some of the components may be omitted in accordance with the use or conditions of the information processing apparatus. For example, in a case where an interface to the user or operator is not to be used, the input device 5103 and the output device 5104 may be omitted. In a case where the portable-type recording medium 5110 or the communication network is not used, the medium driving device 5106 or the network coupling device 5107 may be omitted.

Although the disclosed embodiment and its advantages have been described in detail, those skilled in the art could make various modifications, additions, and omissions without deviating from the scope of the present disclosure clearly recited in claims.

With regard to the embodiments described with reference to FIGS. 2 to 51, the following appendices are further disclosed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
determining, by using each of a plurality of processes included in a matrix process as a first process and using a process next to the first process as a second process, a synchronization method for one or a plurality of processing units that process elements of a first portion of a matrix in parallel, based on the number of the one or the plurality of processing units that process the elements of the first portion of the matrix in parallel in the first process and the number of one or a plurality of processing units that process elements of a second portion of the matrix in parallel in the second process;
executing the first process by using the one or the plurality of processing units that process the elements of the first portion of the matrix in parallel;
executing a synchronization process on the one or the plurality of processing units that process the elements of the first portion of the matrix in parallel by using the synchronization method; and
executing the second process by using the one or the plurality of processing units that process the elements of the second portion of the matrix in parallel.

2. The non-transitory computer-readable recording medium according to claim 1,
wherein the determining of the synchronization method includes determining stream synchronization as the synchronization method in a case where any one of the number of the one or the plurality of processing units that process the elements of the first portion of the matrix in parallel and the number of the one or the plurality of processing units that process the elements of the second portion of the matrix in parallel is equal to or smaller than a group size and the other number is larger than the group size.

3. The non-transitory computer-readable recording medium according to claim 2,
wherein the executing of the synchronization process by using the synchronization method includes applying inter-group synchronization as the synchronization method in a case where the number of the one or the plurality of processing units that process the elements of the first portion of the matrix in parallel is larger than the group size and the number of the one or the plurality of processing units that process the elements of the second portion of the matrix in parallel is larger than the group size.

4. The non-transitory computer-readable recording medium according to claim 2,
wherein the executing of the synchronization process by using the synchronization method includes applying intra-group synchronization as the synchronization method in a case where the number of the one or the plurality of processing units that process the elements of the first portion of the matrix in parallel is equal to or smaller than the group size and the number of the one or the plurality of processing units that process the elements of the second portion of the matrix in parallel is equal to or smaller than the group size.

5. The non-transitory computer-readable recording medium according to claim 1,
wherein the one or the plurality of processing units that process the elements of the first portion of the matrix in parallel process one or a plurality of columns or rows included in the first portion of the matrix in parallel, and the one or the plurality of processing units that process the elements of the second portion of the matrix in parallel process one or a plurality of columns or rows included in the second portion of the matrix in parallel.

6. The non-transitory computer-readable recording medium according to claim 1,
wherein the matrix is an upper triangular matrix or a lower triangular matrix representing coefficients of simultaneous linear equations, and the matrix process is included in a precondition in a solution of the simultaneous linear equations.

7. An information processing apparatus comprising:
a memory; and
a processor coupled to the memory and configured to:
determine, by using each of a plurality of processes included in a matrix process as a first process and using a process next to the first process as a second process, a synchronization method for one or a plurality of processing units that process elements of a first portion of a matrix in parallel, based on the number of the one or the plurality of processing units that process the elements of the first portion of the matrix in parallel in the first process and the number of one or a plurality of processing units that process elements of a second portion of the matrix in parallel in the second process;
execute the first process by using the one or the plurality of processing units that process the elements of the first portion of the matrix in parallel;
execute a synchronization process on the one or the plurality of processing units that process the elements of the first portion of the matrix in parallel by using the synchronization method; and
execute the second process by using the one or the plurality of processing units that process the elements of the second portion of the matrix in parallel.

8. The information processing apparatus according to claim 7,
wherein the processor determines stream synchronization as the synchronization method in a case where any one of the number of the one or the plurality of processing units that process the elements of the first portion of the matrix in parallel and the number of the one or the plurality of processing units that process the elements of the second portion of the matrix in parallel is equal to or smaller than a group size and the other number is larger than the group size.

9. The information processing apparatus according to claim 8,
wherein in an execution of the synchronization process by using the synchronization method, the processor applies inter-group synchronization as the synchronization method in a case where the number of the one or the plurality of processing units that process the elements of the first portion of the matrix in parallel is larger than the group size and the number of the one or the plurality of processing units that process the elements of the second portion of the matrix in parallel is larger than the group size.

10. The information processing apparatus according to claim 8,
wherein in an execution of the synchronization process by using the synchronization method, the processor applies intra-group synchronization as the synchronization method in a case where the number of the one or the plurality of processing units that process the elements of the first portion of the matrix in parallel is equal to or smaller than the group size and the number of the one or the plurality of processing units that process the elements of the second portion of the matrix in parallel is equal to or smaller than the group size.

11. The information processing apparatus according to claim 7,
wherein the one or the plurality of processing units that process the elements of the first portion of the matrix in parallel process one or a plurality of columns or rows included in the first portion of the matrix in parallel, and the one or the plurality of processing units that process the elements of the second portion of the matrix in parallel process one or a plurality of columns or rows included in the second portion of the matrix in parallel.

12. The information processing apparatus according to claim 7,
wherein the matrix is an upper triangular matrix or a lower triangular matrix representing coefficients of simultaneous linear equations, and the matrix process is included in a precondition in a solution of the simultaneous linear equations.

13. An information processing method comprising:
determining, by using each of a plurality of processes included in a matrix process as a first process and using a process next to the first process as a second process, a synchronization method for one or a plurality of processing units that process elements of a first portion of a matrix in parallel, based on the number of the one or the plurality of processing units that process the elements of the first portion of the matrix in parallel in the first process and the number of one or a plurality of processing units that process elements of a second portion of the matrix in parallel in the second process;
executing the first process by using the one or the plurality of processing units that process the elements of the first portion of the matrix in parallel;
executing a synchronization process on the one or the plurality of processing units that process the elements of the first portion of the matrix in parallel by using the synchronization method; and
executing the second process by using the one or the plurality of processing units that process the elements of the second portion of the matrix in parallel.

14. The information processing method according to claim 13,
wherein the determining of the synchronization method includes determining stream synchronization as the synchronization method in a case where any one of the number of the one or the plurality of processing units that process the elements of the first portion of the matrix in parallel and the number of the one or the plurality of processing units that process the elements of the second portion of the matrix in parallel is equal to or smaller than a group size and the other number is larger than the group size.

15. The information processing method according to claim 14,
wherein the executing of the synchronization process by using the synchronization method includes applying inter-group synchronization as the synchronization method in a case where the number of the one or the plurality of processing units that process the elements of the first portion of the matrix in parallel is larger than the group size and the number of the one or the plurality of processing units that process the elements of the second portion of the matrix in parallel is larger than the group size.

16. The information processing method according to claim 14,
wherein the executing of the synchronization process by using the synchronization method includes applying intra-group synchronization as the synchronization method in a case where the number of the one or the plurality of processing units that process the elements of the first portion of the matrix in parallel is equal to or smaller than the group size and the number of the one or the plurality of processing units that process the elements of the second portion of the matrix in parallel is equal to or smaller than the group size.

17. The information processing method according to claim 13,
wherein the one or the plurality of processing units that process the elements of the first portion of the matrix in parallel process one or a plurality of columns or rows included in the first portion of the matrix in parallel, and the one or the plurality of processing units that process the elements of the second portion of the matrix in parallel process one or a plurality of columns or rows included in the second portion of the matrix in parallel.

18. The information processing method according to claim 13,
wherein the matrix is an upper triangular matrix or a lower triangular matrix representing coefficients of simultaneous linear equations, and the matrix process is included in a precondition in a solution of the simultaneous linear equations.
